(19) United States
(12) Patent Application Publication
(10) Pub. No.: US 2004/0234757 A1
(43) Pub. Date: Nov. 25, 2004

(54) Machine crimped synthetic fiber having latent three-dimensional crimpability and method for production thereof

(76) Inventor: Hironori Goda, Matsuyama-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/470,342

(22) PCT Filed: Nov. 22, 2002
(86) PCT No.: PCT/JP02/12244

(30) Foreign Application Priority Data
Nov. 30, 2001 (JP) 2001-366123
Dec. 3, 2001 (JP) 2001-368319

(51) Int. Cl. B32B 19/00

(52) U.S. Cl. 428/357

(57) ABSTRACT

The machine-crimped synthetic fibers of the present invention have a thickness of 0.5 to 200 dtex, a fiber length of 3 to 20 mm and the number of crimps of 1 to 13 crimps/25 mm and a crimp percentage of 2 to 20%, each fiber having two portions disproportional in thermal shrinkage with each other and located in two sides of the fiber divided by an interface by which the fiber is divided along the longitudinal axis of the fiber into two side portions, to cause the fiber to have such a latent crimping property that when heat treated at 60 to 200° C., the two side portions of the fiber disproportionally shrink and the shrunk fiber exhibits three-dimensional crimps having the number of crimps of 15 to 80 crimp/25 mm and a crimp percentage of 25 to 90%. The fibers are produced by disproportionally cool-solidifying in fiber-forming procedure or by forming in an eccentric core-in-sheath type on side-by-side type composite fiber structure.

### TECHNICAL FIELD

The present invention relates to machine-crimped synthetic fibers having latent three-dimensional crimpability and to a process for producing the same.

The machine-crimped synthetic fibers having latent three-dimensional crimpability can form three-dimensional crimped synthetic fibers excellent in bulkiness and uniformity by heat treatment, are useful for producing, for example, air-laid nonwoven fabrics, and include heat-bonding conjugate synthetic fibers.

### BACKGROUND ART

Nonwoven fabrics produced by the air-laid method are characterized in that the fabrics show no difference between the orientation in the longitudinal direction and that in the transverse direction and are uniform in comparison with nonwoven fabrics produced by the conventional card method; the nonwoven fabrics are also characterized in that the fabrics easily manifest high bulkiness in comparison with nonwoven fabrics produced by the paper-making method. The amount of nonwoven fabrics produced by the air-laid method has therefore been significantly increased in recent years. In general, in order to impart high bulkiness to fibers used for air-laid nonwoven fabrics, manifested crimps in a two dimensional zig-zag pattern or a spiral pattern are imparted to the fibers, as disclosed in Japanese Unexamined Patent Publication (Kokai) No. 11-81116. However, when the number of crimps or crimp ratio of the fibers are increased for the purpose of improving the bulkiness, the fiber opening property of the fibers in an air-lay fiber opening stage is deteriorated, and unopened fiber bundles and/or nonuniform webs are often formed. As a result, problems such as those mentioned below often arise: the grade of the appearance of the nonwoven fabrics becomes poor; the strength is decreased; and the quality becomes poor. In particular, when fibers to which spirally manifested crimps are imparted and which have latent crimpability are heat treated while the fabrics are in a state of a filamentary tow or a tow bundle, fibers having manifested crimps form bundles each containing from several to several tens of fibers. These bundles are entangled together to form many unopened fiber bundles, which significantly lower the grade of the appearance of the nonwoven fabrics thus obtained. As explained above, development of fibers suitable for producing air-laid nonwoven fabrics rich in bulkiness and excellent in the grade of the appearance is strongly desired.

Furthermore, in order to produce nonwoven fabrics having high bulkiness and excellent in compression recovery by the air-laid method, attempts have been made to use fibers having various properties. For example, Japanese Unexamined Patent Publication (Kokai) No. 2000-328415 discloses the use of heat-bonding conjugate fibers having a fiber length of from 3 to 40 mm and a relatively large thickness of from 33 to 89 dtex (30 to 80 denier), and also having two-dimensional zig-zag crimps or three-dimensional steric manifested crimps for air-laid nonwoven fabrics. However, when the bulkiness and compression recovery of the conjugate fibers described in the patent publication are improved by increasing manifested crimps, fibers are entangled together in an air-lay fiber opening stage to show a poor fiber opening property and poor dispersibility. As a result, unopened fiber masses remain in the nonwoven fabrics, and the appearance and touch often become poor. However, when the number of crimps is lowered, sufficient bulkiness and compression recovery cannot be imparted to the nonwoven fabrics.

Furthermore, when polyolefin-based conjugate fibers such as polyethylene/polypropylene or polyethylene/poly(ethylene terephthalate) conjugate fibers that are disclosed in the patent publication are used, the following problem arises. When the fibers are used for, for example, carpets and coasters that are used while load is being applied thereto, the fibers are deformed and the bulkiness disappears due to the low rigidity of the fibers themselves, although the bulkiness and compression recovery of the fibers are excellent. Therefore, nonwoven fabrics used for the applications in which the fabrics are loaded must be made to have compression strength, namely, a repulsion property, in addition to the bulkiness.

In addition, conjugate fibers which have a thickness of 30 dtex or more and the sheath and core components of which are both formed from poly(ethylene terephthalate)-based polyester are known to have their own high rigidity and improve the repulsion property of the air-laid nonwoven fabrics. However, poly(ethylene terephthalate)-based polyester conjugate fibers having such a relatively large thickness often have many stuck masses in the sheath component, and have the problem that the manufacture of air-laid nonwoven fabrics having a uniform and beautiful appearance, therefrom, is difficult.

### DISCLOSURE OF THE INVENTION

An object of the present invention is to provide machine-crimped synthetic fibers having latent three-dimensional crimpability that manifests uniform and plenty of three-dimensional crimps by simple heat treatment, a process for producing the same, and fiber products containing three-dimensionally crimped synthetic fibers that are obtained by manifesting the latent crimpability of the machine-crimped synthetic fibers.

A further object of the present invention is to provide machine-crimped synthetic fibers having latent three-dimensional crimpability that manifests many uniform three-dimensional crimps by simple heat treatment, suitable for forming nonwoven fabrics by the air-laid method and capable of imparting high bulkiness, compression elasticity and a good appearance to the nonwoven fabrics, a process for producing the same, and fiber products containing three-dimensionally crimped synthetic fibers that are obtained by manifesting the latent crimpability of the machine-crimped synthetic fibers.

The machine-crimped synthetic fibers that have latent crimpability to manifest three-dimensional crimps according to the present invention comprise as a major component at least one thermoplastic synthetic resin, have an individual fiber thickness of from 0.5 to 200 dtex and a fiber length of from 3 to 20 mm, and show a number of individual fiber crimps of from 1 to 13/25 mm and a crimp ratio of from 2 to 20% imparted by mechanical crimping,

each of the machine-crimped fibers having two portions disproportional in thermal shrinkability on both respective sides of an imaginary interface dividing the fiber into two along the longitudinal axis, the fiber being disproportionately shrunk on both sides thereof when heat treated at temperatures of from 60 to 200° C. due to the presence of the disproportional two portions, whereby the machine-crimped synthetic fibers are made to show a number of three dimensional crimps of from 15 to 80/25 mm and a crimp ratio of from 25 to 90%.

The machine-crimped synthetic fibers according to the present invention preferably show a thermal shrinkage stress peak within the temperatures of from 60 to 180° C.

In the machine-crimped synthetic fibers according to the present invention, the machine-crimped fibers each may have at least one hollow portion continuously extending along the longitudinal direction.

In the machine-crimped synthetic fibers according to the present invention, the machine-crimped fibers each may contain, as a major component, a single type of thermoplastic synthetic resin and have two portions on both respective sides of the imaginary interface disproportional in the orientation degree and/or the crystalline degree.

In the machine-crimped synthetic fibers according to the present invention, the thermoplastic synthetic resin may contain, as a major component, a single type of polyester that contains alkylene terephthalate units as major repeating units.

In the machine-crimped synthetic fibers according to the present invention, the machine-crimped fibers each may comprise two fiber segments containing two respective thermoplastic synthetic resins as major components differing from each other in thermal shrinkability, and the two fiber segments may be mutually bonded together to form an eccentric core-sheath structure along the longitudinal axis of the fiber and asymmetric with respect to the imaginary interface, whereby the conjugate fibers are formed.

In the machine-crimped synthetic fibers according to the present invention, the machine-crimped fibers each may comprise two fiber segments containing two respective thermoplastic synthetic resins as major components differing from each other in thermal shrinkability, and the two fiber segments may be mutually bonded together to form a side-by-side conjugate structure along the longitudinal axis of the fiber with the imaginary interface forming a bonding plane, whereby the conjugate fibers are formed.

In the machine-crimped synthetic fibers according to the present invention, the two types of synthetic resins for forming the eccentric core-sheath or side-by-side conjugate fibers are each preferably selected from polyester resins having alkylene phthalate units as major repeating units and showing a melting point of 200° C. or more.

In the machine-crimped synthetic fibers according to the present invention, the two types of fiber segments forming the eccentric core-sheath conjugate structure are preferably composed of a low-melting point synthetic resin and a high-melting point synthetic resin differing from each other in the melting point by 20° C. or more, the fiber segment that is composed of the low-melting point synthetic resin forming the sheath portion of the eccentric core-sheath conjugate structure, and the fiber segment that is composed of the high-melting point synthetic resin forming the core portion thereof.

In the machine-crimped synthetic fibers according to the present invention, the two types of fiber segments forming the side-by-side conjugate structure are preferably composed of a low-melting point synthetic resin and a high-melting point synthetic resin differing from each other in the melting point by 20° C. or more.

In the machine-crimped synthetic fibers according to the present invention, the low-melting point synthetic resin of the eccentric core-sheath or side-by-side conjugate fibers is preferably selected from polyolefins, and the high-melting point synthetic resin is preferably selected from polyesters containing alkylene phthalate units as major repeating units.

In the machine-crimped synthetic fibers according to the present invention, an isophthalic acid-copolymerized poly(alkylene terephthalate) having a melting point of from 50 to 200° C. is preferably used as the low-melting point synthetic resin of the eccentric core-sheath or side-by-side conjugate fibers, and a poly(alkylene terephthalate) having a melting point higher than that of the low-melting point synthetic resin by 20° C. or more is preferably used as the high-melting point synthetic resin.

In the machine-crimped synthetic fibers according to the present invention, the low-melting point synthetic resin of the eccentric core-sheath or side-by-side conjugate fibers is selected from thermoplastic elastomers having a melting point of from 80 to 200° C.

In the machine-crimped synthetic fibers according to the present invention, the low-melting point synthetic resin of the eccentric core-sheath or side-by-side conjugate fibers is preferably selected from modified polyolefin resins obtained by graft polymerizing a polyolefin with a graft agent containing at least one substance selected from ethylenic unsaturated carboxylic acids and anhydrides thereof.

A production process (1) of the machine-crimped synthetic fibers of the present invention is a process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin filaments that comprises, during cooling and solidifying under draft, a filamentary synthetic resin molten flow prepared by melting a single type of thermoplastic synthetic resin and extruding the molten body through a spinneret into a filamentary flow, blowing cold air toward the one side of the filamentary synthetic resin molten flow in the direction transverse to the molten flow, whereby both sides of the imaginary interface of each filament along the longitudinal axis and transverse to the blowing direction of the cold wind are made disproportional in an orientation degree and/or a crystalline degree;

a drawing stage for producing drawn synthetic resin filaments having a thickness of from 0.5 to 200 dtex that comprises drawing the undrawn synthetic resin filaments at temperatures lower than the heat treatment temperatures for manifesting the crimps;

a machine crimping stage that comprises machine crimping the drawn synthetic resin filaments to impart a number of crimps of from 1 to 13/25 mm and a crimp ratio of from 2 to 20% to the drawn synthetic resin filaments; and

a cutting stage that comprises cutting the machine-crimped synthetic resin filaments into fiber pieces having a crimp length of from 3 to 20 mm.

In the production process (1) according to the present invention, the synthetic resin molten body in the melt spinning stage may be extruded through a spinneret for forming hollow filaments into a hollow filamentary form.

In the production process (1) according to the present invention, the thermoplastic synthetic resin provided to the melt spinning stage preferably comprises as a major component a polyester containing alkylene terephthalate units as major repeating units.

A production process (2) according to the present invention is a process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin eccentric core-sheath conjugate filaments that comprises separately melting two types of thermoplastic synthetic resins differing from each other in thermal shrinkability, extruding the two molten bodies through a spinneret for forming eccentric core-sheath conjugate fibers into a conjugate filamentary form, and cooling and solidifying under a draft the extruded conjugate filamentary synthetic resin molten flow;

a drawing stage for producing drawn synthetic resin filaments having a thickness of from 0.5 to 200 dtex that comprises drawing the undrawn synthetic resin conjugate filaments at temperatures lower than the heat treatment temperatures for manifesting the crimps;

a machine crimping stage that comprises machine crimping the drawn synthetic resin filaments to impart a number of crimps of from 1 to 13/25 mm and a crimp ratio of from 2 to 20% to the drawn synthetic resin filaments; and

a cutting stage that comprises cutting the machine-crimped synthetic resin conjugate filaments into fiber pieces having a crimp length of from 3 to 20 mm.

The production process (3) according to the present invention is a process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin eccentric core-sheath conjugate filaments that comprises separately melting two types of thermoplastic synthetic resins differing from each other in thermal shrinkability, extruding the two molten bodies through a spinneret for forming side-by-side conjugate fibers into a conjugate filamentary form, and cooling and solidifying under a draft the extruded conjugate filamentary synthetic resin molten flow;

a drawing stage for producing drawn synthetic resin conjugate filaments having a thickness of from 0.5 to 200 dtex that comprises drawing the undrawn synthetic resin conjugate filaments at temperatures lower than the heat treatment temperatures for manifesting the crimps;

a machine crimping stage that comprises machine crimping the drawn synthetic resin filaments to impart a number of crimps of from 1 to 13/25 mm and a crimp ratio of from 2 to 20% to the drawn synthetic resin filaments; and

a cutting stage that comprises cutting the machine-crimped synthetic resin conjugate filaments into fiber pieces having a crimp length of from 3 to 20 mm.

In the production process (2) or (3) according to the present invention, the two types of synthetic resins each may have alkylene phthalate units as major repeating units and may be selected from polyester resins having a melting point of 200° C. or more.

In the production process (2) or (3) according to the present invention, the two types of synthetic resins for producing the eccentric core-sheath conjugate fibers are preferably composed of a low-melting point synthetic resin and a high-melting point synthetic resin, respectively, differing from each other in the melting point by 20° C. or more, the sheath portion of the eccentric core-sheath conjugate fibers is preferably formed from the low-melting point synthetic resin, and the core portion thereof is preferably formed from the high-melting point synthetic resin.

In the production process (2) or (3) according to the present invention, the two types of synthetic resins for producing the side-by-side conjugate fibers are preferably a low-melting point synthetic resin and a high-melting point synthetic resin, respectively, differing from each other in the melting point by 20° C. or more.

In the production process (2) or (3) according to the present invention, the low-melting point synthetic resin is preferably selected from polyolefins, and the high-melting point synthetic resin is preferably selected from polyesters containing alkylene phthalate units as major repeating units.

In the production process (2) or (3) according to the present invention, an isophthalic acid-copolymerized poly(alkylene terephthalate) having a melting point of from 50 to 200° C. is preferably used as the low-melting point synthetic resin, and a poly(alkylene terephthalate) having a melting point higher than that of the low-melting point synthetic resin by 20° C. or more is preferably used as the high-melting point synthetic resin.

In the production process (2) or (3) according to the present invention, the low-melting point synthetic resin is preferably selected from a thermoplastic elastomers having a melting point of from 80 to 200° C.

In the production process (2) or (3) according to the present invention, the low-melting point synthetic resin is preferably selected from modified polyolefin resins obtained by graft polymerizing a polyolefin with a graft agent containing at least one substance selected from ethylenic unsaturated carboxylic acids and anhydrides of the acids.

In the production process (2) or (3) according to the present invention, a hot bonding conjugate fibers may be produced by the following procedure wherein the melt spinning stage, a poly(ethylene terephthalate) resin molten body is fed to the spinneret for forming the eccentric core-sheath conjugate fibers as a synthetic resin for forming the core portion, at temperatures of from 265 to 280° C., an isophthalic acid-copolymerized poly(alkylene terephthalate) resin molten body having a melting or softening point of from 50 to 220° C. is fed thereto as a synthetic resin for forming the sheath portion, at temperatures of from 180 to 230° C., and the conjugate filamentary molten flow thus extruded is uniformly cooled and solidified with a cooling wind adjusted to temperatures of from 15 to 40° C.

In the production process (2) or (3) according to the present invention, heat-bonding conjugate fibers may be produced by the following procedure wherein the core portion of the undrawn eccentric core-sheath conjugate filaments is formed from a poly(ethylene terephthalate) resin, the sheath portion is formed from an isophthalic acid-copolymerized poly(alkylene terephthalate) resin having a melting or softening point of from 50 to 220° C., the total draw ratio to be applied to the undrawn conjugate filaments in the undrawing stage is set at from 0.70 to 0.95 times the maximum draw ratio of the undrawn conjugate filaments in hot water at 45° C., the undrawn conjugate filaments are first drawn until the draw ratio reaches from 0.60 to 0.90 times the total draw ratio in hot water at temperatures of from 70 to 80° C., and then the filaments are drawn until the draw in hot water at a temperature of from 70 to 80° C. ratio reaches the total draw ratio designed.

A bulky fiber product according to the present invention contains three-dimensionally crimped synthetic fibers obtained by manifesting the latent crimpability of the machine-crimped synthetic fibers according to the present invention.

An air-laid nonwoven fabric according to the present invention contains three-dimensionally crimped synthetic fibers obtained by manifesting the latent crimpability of the machine-crimped synthetic fibers according to the present invention.

### BRIEF DESCRIPTION OF THE DRAWINGS

FIG. 1 is a cross-sectional explanatory view showing one example of a side-by-side structure in the machine-crimped hollow synthetic fibers of the present invention.

FIG. 2 is a cross-sectional explanatory view showing one example of an eccentric core-sheath structure in the machine-crimped hollow synthetic fibers of the present invention.

### BEST MODE FOR CARRYING OUT THE PRESENT INVENTION

Machine-crimped synthetic fibers that have latent crimpability to manifest three-dimensional crimps according to the present invention comprise, as a major component, at least one thermoplastic synthetic resin, have an individual fiber thickness of from 0.5 to 200 dtex, preferably 1 to 100 dtex, and a fiber length of from 3 to 20 mm, preferably 5 to 15 mm, and show a number of individual fiber crimps of from 1 to 13/25 mm, preferably 2 to 10/25 mm, and a crimp ratio of from 2 to 20%, preferably 5 to 15%, imparted by mechanical crimping,

each of the machine-crimped fibers having two portions disproportional in thermal shrinkability on both respective sides of an imaginary interface dividing the fiber into two along the longitudinal axis, the fiber being disproportionately shrunk on both sides thereof when heat treated at temperatures of from 60 to 200° C. due to the presence of the disproportional two portions, whereby the machine-crimped synthetic fibers are made to show a number of crimps of from 15 to 80/25 mm, preferably 20 to 70/25 mm and a crimp ratio of from 25 to 90%, preferably 30 to 60%.

The crimps of the machine-crimped fibers of the present invention are approximately two dimensionally formed. Such mechanical crimps are imparted with a mechanical crimping apparatus such as a gear crimping apparatus and a stuffer box crimping apparatus. Moreover, manifestation of the latent crimpability by heat treatment of the machine-crimped fibers is carried out while the fibers are in a relaxed state; the fibers are each asymmetrically shrunk on both sides of one imaginary interface (the interface may be either a flat surface or a curved surface) that divides the fiber into two along the longitudinal axis, whereby spiral three-dimensional crimps are manifested.

When the individual fiber thickness of the machine-crimped fibers according to the present invention is less than 0.5 dtex, the spiral diameter of the spiral three-dimensional crimps manifested by heat treatment becomes so small that the bulkiness of the fiber product containing the fibers thus obtained in which crimps are manifested such as air-laid nonwoven fabrics becomes insufficient. When the individual fiber thickness exceeds 200 dtex, the aspect ratio (fiber length/individual fiber thickness ratio) of the fibers becomes so small that the fiber-to-fiber density in the machine-crimped fiber product becomes excessive. As a result, free manifestation of the three-dimensional crimps by heat treatment is hindered, and the bulkiness of the thus obtained fiber product in which three-dimensional crimps are manifested (such as air-laid nonwoven fabrics) becomes inadequate.

When the fiber length of the machine-crimped fibers is less than 3 mm, the mechanical strength of the machine-crimped fiber product thus obtained becomes insufficient, and the bulkiness effect of the three-dimensional crimped fiber product after heat treatment becomes inadequate. Moreover, when the fiber length exceeds 20 mm, entanglement among the machine-crimped fibers becomes significant. Consequently, for example, in the air-lay fiber opening stage of the machine-crimped fibers, fiber opening of the fibers becomes poor, and the uniformity of the distribution of the machine-crimped fibers in the air-laid nonwoven fabrics thus obtained becomes insufficient.

Mechanical crimps formed in the synthetic fibers in corporation with three-dimensional crimps manifested by heat treatment usually give a preferable bulky structure to fiber products formed from the fibers. However, the present inventors have made a discovery as explained below. When the crimped shape of the fibers prior to heat treatment is not a mechanical (two dimensional) crimped shape, but a three-dimensional crimped shape, or the number of mechanical crimps exceeds 13/25 mm, or the mechanical crimp ratio exceeds 20%, entanglement among fibers becomes excessive, and separation of individual fibers (fiber opening) becomes difficult. For example, air-lay fiber opening of the fibers becomes insufficient in the air-lay fiber opening stage, and the phenomenon that uniform webs cannot be formed takes place. In the present invention, the present inventors therefore have succeeded in imparting a good individual fiber separating property such as a fiber opening (air lay opening) property to the latent three-dimensional crimpable machine-crimped synthetic fibers, and applying high bulkiness to the fiber products in which three-dimensional crimps are manifested by making the manifested crimp shape of the machine-crimped fibers prior to heat treatment approximately two-dimensional crimps with a number of crimps of from 1 to 13/25 mm and a crimp ratio of from 2 to 20%. In the present invention, mechanical crimps include zig-zag type crimps the tips of which are crooked at sharp angles and Q type crimps that form bent curved lines, and signify crimps that are formed approximately in a flat surface, namely, two-dimensional crimps.

The machine-crimped synthetic fibers of the present invention must have latent crimpability that manifests spiral three-dimensional crimps by heat treatment at temperatures of from 60 to 200° C. However, when the fibers have latent a crimpability that starts to manifest itself at temperatures lower than 60° C., three-dimensional crimps are manifested by a fretting heat in the production stage of fiber products, for example, in the web-forming stage by the air-laid method. As a result, the problem, that the fiber opening property and/or fiber dispersibility by airflow is deteriorated, arises. Moreover, when the starting temperature of three-dimensional crimp manifestation exceeds 200° C., latent crimpable fibers cannot manifest three-dimensional crimps adequately at ordinary processing temperatures, for example, at heat treatment temperatures in the air-laid stage. Sufficient bulkiness therefore cannot be applied to desired fiber products such as air-laid nonwoven fabrics.

Furthermore, when the number of crimps of fibers having manifested crimps by heat treatment at temperatures of from 60 to 200° C. is less than 15/25 mm, or the crimp ratio is less than 25%, fiber products in which crimps are manifested such as nonwoven fabrics cannot manifest adequate bulkiness. Moreover, when the number of crimps of the crimp-manifestation fibers obtained by heat treatment at temperatures of from 60 to 200° C. exceeds 80/25 mm or the crimp ratio exceeds 90%, the gaps among individual fibers of the thus obtained fiber products in which crimps are manifested such as nonwoven fabrics are small, and the fiber products become fiber bulk materials in which individual fibers are densely packed. As a result, sufficient bulkiness cannot be manifested in the thus obtained fiber products in which crimps are manifested such as nonwoven fabrics.

Furthermore, as a result of observing and analyzing in detail the thermal shrinkage behavior of the machine-crimped fibers of the present invention when the fibers are heat treated in the air-laid heat treatment stage or the like, the present inventors have found that when the temperature at which the machine-crimped fibers show a thermal shrinkage stress peak is from 60 to 180° C., a more enhanced heat treatment effect can be manifested. The term “thermal shrinkage stress” used herein is a shrinkage stress measured with a conventional shrinkage stress measurement apparatus by preparing a ring test piece from a test yarn 5 cm long of the machine-crimped fibers, holding both end portions of the yarn test piece with two measuring and holding portions opposite to each other and heating at a heating rate of 120 sec/300° C. with an initial load of 0.09 cN/dtex. The temperature at which the shrinkage stress becomes maximum is defined as a thermal shrinkage stress peak temperature. When the machine-crimped fibers show a thermal shrinkage stress peak temperature of less than 60° C., fretting or the like imparted to the fibers manifests three-dimensional crimps prior to heat treatment during the stage of producing fiber products from the machine-crimped fibers, for example, during the stage of producing air-laid nonwoven fabrics. As a result, the dispersibility of the fibers during the stage is sometimes lowered. Moreover, when the fibers show a thermal shrinkage stress peak temperature exceeding 180° C., latent crimp manifestation during heat treatment sometimes become inadequate. In addition, in order to manifest the heat treatment effect, the thermal shrinkage stress peak temperature is preferably from 70 to 160° C.

The machine-crimped synthetic fibers having three-dimensional crimpability contain as a major component a synthetic polymer, and the fibers alone may be used for producing bulky fiber products such as air-laid nonwoven fabrics. Alternatively, the machine-crimped synthetic fibers may also be blended with natural fibers such as pulp or cotton, regenerated fibers such as rayon, semi-synthetic fibers such as acetate and/or synthetic polymer fibers having crimpability and/or shrinkage physical properties different from those of fibers mentioned above, and used for producing bulky fabrics such as air-laid nonwoven fabrics.

Furthermore, the machine-crimped fibers having latent three-dimensional crimpability of the present invention may be formed from a single synthetic resin, or they may be conjugate fibers formed from two types of synthetic resins. Moreover, each of the former and the latter fibers may not have properties as a binder, or may be used as heat-bonding fibers having binding properties. The type, construction and properties of synthetic polymers to be used for the machine-crimped fibers of the present invention must be appropriately designed according to the application and use thereof.

First, when the machine-crimped fibers of the present invention are formed from a single synthetic resin, a polyester having an alkylene terephthalate as a major component is preferably used as a synthetic polymer to form the fibers. A polyester having an alkylene terephthalate as a major component signifies a polyester in which 80% by mole or more of monomers forming the synthetic polymer are alkylene terephthalate, and includes poly(alkylene terephthalates) such as poly(ethylene terephthalate), poly(trimethylene terephthalate) and poly(butylene terephthalate). The polyester may also contain one or two or more of other dicarboxylic acid components, oxycarboxylic acid components and diol components as copolymerization units.

In the above copolymerized polyesters, examples of the other dicarboxylic acid components include aromatic dicarboxylic acids such as diphenyldicarboxylic acid and naphthalenedicarboxylic acid or ester-forming derivatives of the aromatic dicarboxylic acids, metal sulfo group-containing aromatic carboxylic acid derivatives such as dimethyl 5-sodiosulfoisophthalate and bis(2-hydroxyethyl) 5-sodiosulfoisophthalate, and fatty dicarboxylic acids such as oxalic acid, adipic acid, sebacic acid and dodecanedicarboxylic acid or ester-forming derivatives of the fatty dicarboxylic acids. Moreover, examples of the oxycarboxylic acid components for copolymerized polyesters include p-oxybenzoic acid, p-β-oxyethoxybenzoic acid or ester-forming derivatives of the above oxycarboxylic acids.

Examples of the diol components for copolymerized polyesters include fatty diols such as ethylene glycol, diethylene glycol, 1,3-propanediol, 1,4-butanediol, 1,6-hexanediol and neopentyl glycol, and polyalkylene glycols such as 1,4-bis(β-oxyethoxy)benzene, poly(ethylene glycol), poly(trimethylene glycol) and poly(butylene glycol).

An appropriate alkylene terephthalate is selected according to the object of use from the above polyesters and copolymerized polyesters, and fibers having an individual fiber thickness, a fiber length, manifested machine-crimped properties and latent crimpability that satisfy the requirements of the present invention are prepared. The machine-crimped synthetic fibers having latent three-dimensional crimpability of the present invention can be produced by the following process.

That is, one embodiment of a process for producing the latent three-dimensional crimpable machine-crimped fibers of the present invention (hereinafter referred to as production process (1)) is a process for producing the machine-crimped synthetic fibers according to the present invention that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin filaments that comprises, during cooling and solidifying under a draft a filamentary synthetic resin molten flow prepared by melting a single type of thermoplastic synthetic resin and extruding the molten body through a spinneret into a filamentary flow, blowing cold air toward the one side of the filamentary synthetic resin molten flow in the direction transverse to the molten flow, whereby both sides of one imaginary interface of each filament along the longitudinal axis and transverse to the blowing direction of the cold air are made disproportional in an orientation degree and/or a crystalline degree;

a drawing stage for producing drawn synthetic resin filaments having a thickness of from 0.5 to 200 dtex that comprises drawing the undrawn synthetic resin filaments at temperatures lower than the heat treatment temperatures for manifesting the crimps;

a machine crimping stage that comprises machine crimping the drawn synthetic resin filaments to impart a number of crimps of from 1 to 13/25 mm and a crimp ratio of from 2 to 20% to the drawn synthetic resin filaments; and

a cutting stage that comprises cutting the machine-crimped synthetic resin filaments into fiber pieces having a crimp length of from 3 to 20 mm.

In the production process (1) of the present invention, for example, a pelletized synthetic resin such as a pelletized polyester is dried by a conventional method, and melt spun with a melt spinning apparatus equipped with a screw extruder, etc. The extruded filamentary synthetic resin molten flow is subjected to asymmetric cooling to form undrawn filaments, whereby orientation anisotropy is imparted to the resultant undrawn filaments in the direction transverse to the longitudinal direction thereof. The undrawn filaments in a stretched or relaxed state are bundled without giving a heat history at temperatures above the heat treatment temperature mentioned above. More specifically, a gas at temperatures of from 10 to 40° C. is blown onto a filamentary synthetic resin molten flow at a site 1 to 50 mm below the spinneret in one direction making an angle of from +20 to −20° with a plane vertical to the proceeding direction of the filamentary flow to cool and solidify the filamentary molten flow. The undrawn filaments thus obtained are wound at a rate of from 500 to 3,000 m/min. The undrawn filaments are drawn, and finish oil is optionally applied. The filaments are then machine crimped, and cut into fiber pieces having a fiber length of from 3 to 20 mm.

The type and amount of the applied finish oil is selected and designed according to the use and desired properties of the machine-crimped fibers.

In addition, the above drawing is preferably neck drawing at temperatures of from 10 to 80° C. (at temperatures up to the above heat treatment temperature). When the filaments are drawn at temperatures exceeding 80° C., or heat treated at high temperatures exceeding 80° C. while the filaments are in a stretched or relaxed state, the orientation anisotropy is sometimes impaired or the filaments sometimes manifest no predetermined three-dimensional crimps. Attention must therefore be paid to not produce such phenomena. Moreover, the filaments subsequent to drawing may be heat treated for a short period of time in order to adjust a number of crimps and a crimp ratio to be determined by the following machine crimping.

Furthermore, in order to impart three-dimensional crimpability to the fibers, the draw ratio in the neck drawing is preferably set at up to 0.9 times the maximum cold draw ratio of the undrawn filaments. The cold draw ratio of the undrawn filaments herein signifies a value obtained in the following manner. A sample of undrawn filaments taken within 5 minutes directly after spinning are drawn in an air atmosphere at 25° C. at a relative humidity of 65% at a rate of 5 cm/sec with a chuck-to-chuck distance set at 10 cm. The chuck-to-chuck distance (cm) measured when the sample is no longer elongated is divided by the initial chuck-to-chuck distance (10 cm) to give the value.

In addition, in order to impart sufficient asymmetry of the orientation degree and/or crystalline degree to the fibers, the cooling gas flow rate is preferably 0.4 m/sec, more preferably 0.8 m/sec or more. Moreover, the cross-sectional shape of the machine-crimped fibers may be either solid or hollow. The fibers may have a shape-modified solid cross-sectional shape or a shape-modified hollow cross-sectional shape such as a triangle shape or a star shape. In order to impart a higher three-dimensional crimpability to the fibers, the fibers are preferably made hollow ones. The above hollow fibers and/or shape-modified ones can be obtained by melt spinning with known spinnerets.

The machine-crimped synthetic fibers of the present invention may be conjugate ones formed from two types of fiber segments different from each other in heat shrinkability. The two types of fiber segments extend in a fibrous form along the longitudinal axis of the conjugate fibers, and are united together to form conjugate fibers.

In one example of the machine-crimped conjugate synthetic fibers of the present invention, the machine-crimped fibers each comprise two fiber segments containing two respective thermoplastic synthetic resins as major components differing from each other in thermal shrinkability, and the two fiber segments are mutually bonded together to form an eccentric core-sheath structure along the longitudinal axis of the fiber and asymmetric with respect to the imaginary interface, whereby the conjugate fibers are formed.

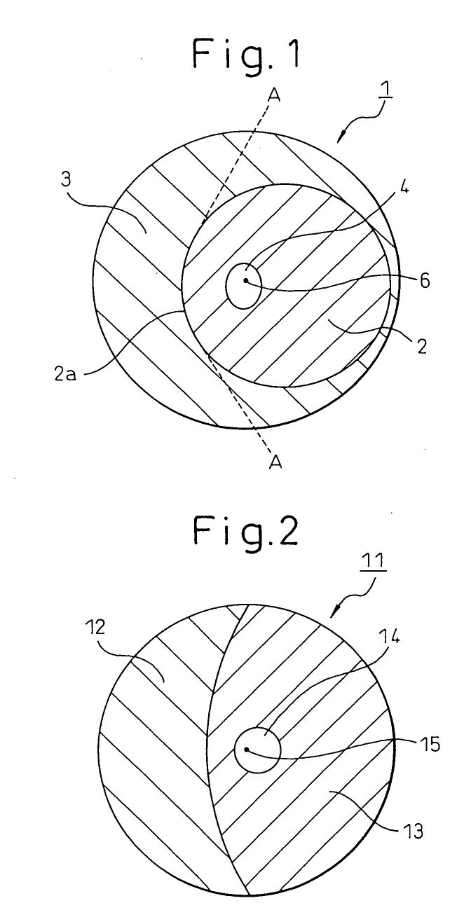

For example, in a cross-sectional view of a conjugate fiber shown in FIG. 1, an eccentric core-sheath conjugate fiber 1 of the present invention is formed from a core segment 2 and a sheath segment 3 formed from two respective synthetic resins differing from each other in thermal shrinkability. The core segment 2 is eccentrically arranged in the sheath segment 3, and a hollow portion 4 is formed in the core segment 2. The center of the hollow portion 4 may be situated either at a center 6 of the cross section of the conjugate fiber 1 or off the center 6 (eccentrically). The conjugate fiber shown in FIG. 1 exhibits heat shrinkability disproportionally on both sides of an imaginary interface A-A parallel to the longitudinal axis of the conjugate fiber. The imaginary interface A-A includes a portion 2a of a peripheral surface of the core segment 2 near the center 6 of the conjugate fiber 1. In FIG. 1, the entire core segment 2 is situated on the right side of the imaginary interface AA, and most of the sheath segment 3 is situated on the left side thereof. When the thermal shrinkage ratio of the core segment 2 is higher than that of the sheath segment 3, heat treatment of the conjugate fiber spirally crimps the fiber with the right side portion of the fiber containing the core segment 2 placed inside the fiber. When the thermal shrinkage ratio of the sheath segment 3 is higher than that of the core segment 2, heat treatment of the conjugate fiber spirally crimps the fiber with the left side portion of the fiber containing the thick portion of the sheath segment 3 placed inside the fiber.

In another example of the machine-crimped conjugate synthetic fibers of the present invention, the machine-crimped fibers each comprise two fiber segments containing two respective thermoplastic synthetic resins as major components differing from each other in thermal shrinkability, and the two fiber segments are mutually bonded together to form a side-by-side conjugate structure along the longitudinal axis of the fiber with the imaginary interface forming a bonding plane, whereby the conjugate fibers are formed.

FIG. 2 shows the cross section of one example of such a side-by-side conjugate fiber. In FIG. 2, a side-by-side conjugate fiber 11 is formed from two fiber segments 12, 13 differing from each other in heat shrinkability, and a hollow portion 14 may optionally be formed at least in the segment 12 or 13. In FIG. 2, the hollow portion 14 is formed in the segment 13. A center 15 in the hollow portion 14 may agree with the center of the conjugate fiber 11, or may be off the center (eccentric). Because the conjugate fiber shown in FIG. 2 exhibits heat shrinkability disproportional on both sides of a bonded interface between the segment 12 and the segment 13, heat treatment of the conjugate fiber spirally crimps the fiber with the segment having higher shrinkability placed inside the fiber.

The machine-crimped fibers with latent three-dimensional crimpability of the invention can be produced from two types of synthetic resins differing from each other in heat shrinkability.

One embodiment of such a production process using two types of synthetic resins (hereinafter referred to as the production process (2)) is a process for producing the machine-crimped synthetic fibers according to the present invention that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin eccentric core-sheath type conjugate filaments that comprises separately melting two types of thermoplastic synthetic resins differing from each other in thermal shrinkability, extruding the two molten bodies through a spinneret for forming eccentric core-sheath type conjugate fibers into a conjugate filamentary form, and cooling and solidifying under a draft the extruded conjugate filamentary synthetic resin molten flow;

a drawing stage for producing drawn synthetic resin filaments having a thickness of from 0.5 to 200 dtex that comprises drawing the undrawn synthetic resin conjugate filaments at temperatures lower than the heat treatment temperatures for manifesting the crimps;

a machine crimping stage that comprises machine crimping the drawn synthetic resin filaments to impart a number of crimps of 12/25 mm and a crimp ratio of 20% or less to the drawn synthetic resin filaments; and

a cutting stage that comprises cutting the machine-crimped synthetic resin conjugate filaments into fiber pieces having a crimp length of from 3 to 20 mm.

Furthermore, another embodiment (hereinafter referred to as the production process (3)) is a process for producing the machine-crimped synthetic fibers according to the present invention that have latent three-dimensional crimpability to manifest a number of crimps of from 15 to 80/25 mm and a crimp ratio of from 25 to 90% when subjected to crimp manifestation heat treatment at temperatures of from 60 to 200° C.,

the process comprising:

a melt spinning stage for producing undrawn synthetic resin eccentric core-sheath type conjugate filaments that comprises separately melting two types of thermoplastic synthetic resins differing from each other in thermal shrinkability, extruding the two molten bodies through a spinneret for forming side-by-side type conjugate fibers into a conjugate filamentary form, and cooling and solidifying under a draft the extruded conjugate filamentary synthetic resin molten flow;

a drawing stage for producing drawn synthetic resin conjugate filaments having a thickness of from 0.5 to 200 dtex that comprises drawing the undrawn synthetic resin conjugate filaments at temperatures lower than the heat treatment temperatures for manifesting the crimps;

a machine crimping stage that comprises machine crimping the drawn synthetic resin filaments to impart a number of crimps of 12/25 mm and a crimp ratio of 20% or less to the drawn synthetic resin filaments; and

a cutting stage that comprises cutting the machine-crimped synthetic resin conjugate filaments into fiber pieces having a crimp length of from 3 to 20 mm.

In the production processes (2), (3) of the present invention described above, two types of synthetic resins (synthetic polymers optionally containing pigments and other additives) are each dried under conditions suitable for each resin. The two types of dried synthetic resins in pellets are melted with two conjugate spinning apparatuses, respectively, each equipped with a melting and mixing apparatus of synthetic polymer such as a screw extruder. The two types of molten bodies thus obtained are conjugated and extruded in an eccentric core-sheath manner or a side-by-side manner with a conjugate spinneret for forming eccentric core-sheath or side-by-side conjugate fibers. The conjugate filamentary molten flow thus extruded is taken up at a rate of, for example, from 150 to 3,000 m/min while being air cooled with a cooling wind so that the fibers are subjected to necessary drawing and machine crimping. Finish oil for imparting desired properties to the fibers is optionally applied to the fibers. The fibers are then cut into fiber pieces having a predetermined fiber length. In addition, drawing conducted between winding and application of finish oil may also be neck drawing at temperatures of from 10 to 80° C. Moreover, machine crimping can be conducted with a gear crimping machine or a stuffer box crimping machine. In the stages of drawing and crimping, a heat history that exerts adverse effects on the three-dimensional crimpability must not be given to the fibers. In particular, when the fibers are drawn at temperatures exceeding 80° C. or heat treated at temperatures as high as greater than 80° C. while being in a stretched or relaxed state, the asymmetry of the orientation degree is decreased, and desired three-dimensional crimping is not manifested sometimes. However, in order to adjust a number of mechanical crimps and a crimp ratio, the fibers may be heat treated for a short period of time as long as adverse effects are not exerted on the three-dimensional crimpability.

In the production processes (2) and (3) of the present invention, preferred examples of the synthetic resins that form two fiber segments forming the conjugate fibers include, in addition to polyesters containing as major components alkylene terephthalate, a polypropylene, a high-density polyethylene, a medium-density polyethylene, a low-density polyethylene, a linear low-density polyethylene, a crystalline polypropylene-based copolymer prepared from propylene and α-olefin (including ethylene), polyolefins including copolymers of an olefin and at least two substances selected from an ethylenic unsaturated carboxylic acid, an anhydride, an ester and a metal salt (saponified product) of an ethylenic unsaturated carboxylic acid, a polyamide, a fluoro resin and a mixture of these synthetic polymers. Of these substances, a suitable combination of two types of synthetic polymers is preferably selected according to the application.

Of the polymers for the two types of synthetic resins mentioned above, a combination of polyesters containing alkylene terephthalate having a melting point of 200° C. or more are preferably used as polymers used for the principal fibers. When the polymers are used as explained above, use of the principal fibers obtained therefrom and binder fibers in a blend can allow the properties of the principal fibers to remain without melting. One typical example is a combination of two types of polyesters containing alkylene terephthalate as major components and each showing an intrinsic viscosity differing from that of the other polyester by 0.1 dl/g or more measured at 35° C. in o-chlorophenol: for example, a combination of (poly(alkylene terephthalate))/(poly(alkylene terephthalate) copolymerized with 20% by mole or less of isophthalic acid and/or 5-sodiosulfoisophthalic acid).

Furthermore, when the machine-crimped conjugate synthetic fibers of the present invention are used as heat-bonding fibers having binding properties, a combination of a low-melting point synthetic polymer and a high-melting point synthetic polymer with a melting point difference of 20° C. or more, preferably from 30 to 200° C. are preferably used. When there is a melting point difference of 20° C. or more between the two polymers, a fiber segment containing the high-melting point synthetic polymer as a principal component remains as a fiber-forming component without melting during heat-bonding treatment, and the bulkiness of the nonwoven fabric is maintained. In addition, in order for the fibers of the invention to have properties as a binder, the fiber segment having a low melting point synthetic polymer as a major component must be continuously formed in the longitudinal direction of the fibers along at least a portion of the conjugate fiber surface. The conjugate mass ratio of the two fiber segments containing the respective two types of synthetic polymers is preferably as follows: a low-melting point synthetic polymer-containing segment/high-melting point synthetic polymer-containing segment ratio=80/20 to 20/80. For the eccentric core-sheath conjugate fibers, when the core segment content in terms of mass of the eccentric core-sheath conjugate fiber exceeds 80% by mass, the binder effects as heat-melting fibers become insignificant because the sheath segment becomes small. Moreover, when the core segment content in terms of mass is less than 20% by mass, adjustment of the latent three-dimensional crimpability to an appropriate level becomes difficult. A still preferred range of the core segment content in terms of mass is as follows: core/sheath ratio of from 70/30 to 30/70.

Furthermore, when a polyolefin and a poly(alkylene terephthalate) are used as a low-melting point synthetic polymer and a high-melting point synthetic polymer, respectively, in conjugate fibers, necessary mechanical crimps (number of crimps and crimp ratio) can be surely imparted, and more excellent three-dimensional crimps can be manifested by heat treatment.

Furthermore, for conjugate fibers wherein an isophthalic acid-copolymerized poly(alkylene terephthalate) having a melting or softening point of from 50 to 200° C. is used as a low-melting point synthetic polymer, and a poly(alkylene terephthalate) is used as a high-melting point synthetic polymer, necessary mechanical crimps (number of crimps and crimp ratio) can be imparted to the fibers more surely, and heat treatment of the fibers can manifest more excellent three-dimensional crimps. When the fibers are to be heat treated, the isophthalic acid-copolymerized poly(alkylene terephthalate) used as a low-melting point synthetic polymer may be crystalline or amorphous. However, the melting or softening point is preferably from 50 to 200° C. When the melting or softening point is less than 50° C., during formation of, for example, an air-laid web, fretting heat causes the heat-bonding conjugate fibers to manifest three-dimensional crimps, or the binder fibers are bonded together due to fretting heat. Moreover, when the melting or softening point exceeds 200° C., the low-melting point fiber segments thus obtained show an excessively high melting point as a binder, and heat treatment hardly causes the conjugate fibers to manifest three-dimensional crimps.

Typical examples of the above isophthalic acid-copolymerized poly(alkylene terephthalate) include a poly(ethylene terephthalate) copolymer prepared by copolymerizing with from 20 to 60% by mole of isophthalic acid as an acid component, a poly(trimethylene terephthalate) copolymer prepared by copolymerizing with from 5 to 60% by mole of isophthalic acid as an acid component, a poly(butylene terephthalate) copolymer prepared by copolymerizing with from 3 to 55% by mole of isophthalic acid as an acid component, and a poly(hexamethylene terephthalate) copolymer prepared by copolymerizing with from 1 to 20% by mole of isophthalic acid as an acid component. In general, when the stiffness and repulsion property of fiber products such as nonwoven fabrics are taken into consideration, use of an isophthalic acid-copolymerized poly(ethylene terephthalate) is preferred.

Furthermore, as long as the melting or softening point is in the above range, alkylene terephthalate may further be copolymerized with an additional acid component containing at least one of the substances such as 2,6-naphthalenedicarboxylic acid, 5 -sodiosulfoisophthalic acid, adipic acid, sebacic acid, azelaic acid, dodecanoic acid and 1,4-cyclohexanedicarboxylic acid and/or an additional diol component containing at least one of the substances such as ethylene glycol, 1,3-propanediol, 1,4-butanediol, 1,5-pentanediol, 1,6-hexanediol, diethylene glycol, 1,4-cyclohexanediol and 1,4-cyclohexanedimethanol.

Furthermore, the heat-bonding conjugate fibers of the present invention containing a thermoplastic elastomer having a melting point of from 80 to 200° C. as a constituent of a heat-bonding fiber segment can be easily subjected to various processing stages such as an air-laid processing stage, and can form fiber products such as webs having more excellent uniformity and appearance.

Polyurethane-based elastomers, polyester-based elastomers, and the like can be used as the thermoplastic elastomers. Examples of the polyurethane-based elastomers include polymers obtained by the reaction of (1) a low-melting point polyol having a molecular weight of from about 500 to 6,000 such as a dihydroxypolyether, a dihydroxypolyester, a dihydroxypolycarbonate or a dihydroxypolester amide, (2) an organic diisocyanate having a molecular weight of 500 or less such as p,p′-diphenylmethane diisocyanate, tolylene diisocyanate, isophorone diisocyanate, hydrogenated diphenylmethane diisocyanate, xylylene diisocyanate, 2,6-diisocyanate methyl caproate or hexamethylene diisocyanate, and (3) a chain extender having a molecular weight of 500 or less such as a glycol, an amino alcohol or a triol.

Of these polymers, polyurethane prepared by using poly(tetramethylene glycol), poly-ε-caprolactone or poly(butylene adipate) as a polyol is particularly preferred. In this case, use of p,p′-diphenylmethane diisocyanate as an organic diisocyanate is preferred. Use of p,p′-bishydroxyethoxybenzene and/or 1,4-butanediol as a chain extender is preferred.

On the other hand, examples of the polyester-based elastomers include polyether ester block copolymers prepared by copolymerizing a thermoplastic polyester as a hard segment and a poly(alkylene oxide) glycol as a soft segment. More specifically, three-component copolymers formed from (1) at least one dicarboxylic acid selected from aromatic dicarboxylic acids such as terephthalic acid, isophthalic acid, phthalic acid, naphthalene-2,6-dicarboxylic acid, naphthalene-2,7-dicarboxylic acid, diphenyl-4,4-dicarboxylic acid, diphenoxyethanedicarboxylic acid and sodium 3-sulfoisophthalate, alicyclic dicarboxylic acids such as 1,4-cyclohexanedicarboxylic acid, aliphatic dicarboxylic acids such as succinic acid, oxalic acid, adipic acid, sebacic acid, dodecandicarboxylic acid and dimeric acid, and ester-forming derivatives of these dicarboxylic acids, (2) at least one diol component selected from aliphatic diols such as 1,4-butanediol, ethylene glycol, trimethylene glycol, tetramethylene glycol, pentamethylene glycol, hexamethylene glycol, neopentyl glycol and decamethylene glycol and alicyclic diols such as 1,1-cyclohexanedimethanol, 1,4-cyclohexanedimethanol and tricyclodecanedimethanol, and ester-forming derivatives of these diols, and (3) at least one substance selected from poly(alkylene oxide) glycols having an average molecular weight of from about 400 to 5,000 such as poly(ethylene glycol), poly(1,2- and 1,3-propylene oxide) glycol, poly(tetramethylene oxide) glycol, a copolymer of ethylene oxide and propylene oxide and a copolymer of ethylene oxide and tetrahydrofuran are employed.

Furthermore, the conjugate fibers of the present invention containing as a heat-bonding component a modified polyolefin that is formed by graft polymerizing a synthetic polymer having high surface friction such as a polyolefin with unsaturated compounds including at least one compound selected from unsaturated carboxylic acids and unsaturated carboxylic acid anhydrides having a melting point of from 80 to 200° C. show good processability, for example, air-laid processability. As a result, fiber products such as webs having excellent uniformity and appearance can be produced.

Examples of the modified polyolefin in which a polyolefin is graft polymerized with ethylenic unsaturated compounds (hereinafter referred to as vinyl monomers) including at least one substance selected from ethylenic unsaturated carboxylic acids and ethylenic unsaturated carboxylic acid anhydrides having a melting point of from 80 to 200° C. include monomers including at least one substance selected from ethylenic unsaturated carboxylic acids and the anhydrides thereof, specifically, monomers including as an essential modifying major component an unsaturated carboxylic acid or the anhydride thereof selected from maleic anhydride, maleic acid, acrylic acid, methacrylic acid and the like, and additional vinyl monomers other than the substances mentioned above.

Furthermore, examples of the additional vinyl monomer are general purpose monomers excellent in radical polymerizability including styrenes such as styrene and α-methylstyrene, methacrylic esters such as methyl methacrylate, ethyl methacrylate, 2-hydroxyethyl methacrylate and dimethylaminoethyl methacrylate, and similar acrylic esters.

A graft polymerization amount of the vinyl monomers in the modified polyolefin is preferably from 0.05 to 2 moles per kg of the polyolefin used as a backbone polymer. Of the graft polymerization amount, a total graft molecular amount of an unsaturated carboxylic acid or an unsaturated carboxylic anhydride as a modifying principal component is preferably from 0.03 to 2 moles/kg.

Graft polymerizing the backbone polymer with such vinyl monomers can be carried out by a conventional procedure. For example, using a radical initiator, the polyolefin is mixed with an unsaturated carboxylic acid or an unsaturated carboxylic anhydride and optionally an additional vinyl monomer so that side chains composed of a random copolymer can be introduced. Alternatively, the polyolefin is successively graft polymerized with at least two types of vinyl monomers so that side chains composed of a block copolymer can be introduced.

Examples of the backbone polymer of the modified polyolefins include polyethylene, polypropylene and polybutene-1. Examples of the polyethylene include a high-density polyethylene, a linear low-density polyethylene and a low-density polyethylene. The backbone polymers are homopolymers or copolymers with another α-olefin, having a density of from 0.90 to 0.97 g/cm³, and have a melting point of from about 100 to 135° C. The polypropylene is a crystalline polymer having a melting point of from 130 to 170° C., and includes a homopolymer or a copolymer with other olefins. The polybutene-1 is a crystalline polymer having a melting point of from 110 to 130° C., and includes a homopolymer or a copolymer with other olefins.

Of these polymers, polyethylene is preferably used in view of the melting point range and easiness of graft reaction. A single type of a modified polyolfin or a mixture of at least two types of the above-modified polyolefins may be used as the modified polyolefin. Alternatively, a mixture of at least one type of a modified polyolefin and at least one type of a backbone polymer may be used as the modified polyolefin.

In one embodiment of the production process (2) in the present invention, a molten poly(ethylene terephthalate) resin as a core-forming synthetic resin is fed to the spinneret for forming the eccentric core-sheath conjugate fibers at temperatures of from 265 to 280° C. in the melt spinning stage, and a molten isophthalic acid-copolymerized poly(alkylene terephthalate) resin having a melting or softening point of from 50 to 220° C. is fed thereto at temperatures of from 180 to 230° C.; the conjugate filamentary molten flow thus extruded is uniformly cooled with a cooling wind adjusted to temperatures of from 15 to 40° C. to be solidified.

In another embodiment of the production process (2) in the present invention, the process is carried out as follows: the core portion of the undrawn eccentric core-sheath conjugate filaments is formed from a poly(ethylene terephthalate) resin; the sheath portion is formed from an isophthalic acid-copolymerized poly(alkylene terephthalate) resin having a melting or softening point of from 50 to 220° C.; the total draw ratio to be applied to the undrawn conjugate filaments in the undrawing stage is set at from 0.70 to 0.95 times the maximum draw ratio of the undrawn conjugate filaments in hot water at 45° C.; the undrawn conjugate filaments are first drawn until the draw ratio reaches from 0.60 to 0.90 times the total draw ratio in hot water at temperatures of from 70 to 80° C.; and then the filaments are drawn in hot water at temperatures of from 60 to 80° C. until the draw ratio reaches the total draw ratio designed.

The machine-crimped conjugate fibers obtained by the above embodiment of the production method (2) in the present invention are useful as heat-bonding polyester conjugate fibers. After drawing the conjugate filaments until the draw ratio reaches from 0.60 to 0.90 times the total draw ratio, the conjugate filaments are drawn in hot water at temperatures of from 60 to 80° C. until the draw ratio reaches the total draw ratio to give the polyester heat-bonding conjugate fibers of the present invention.

The heat-bonding polyester conjugate fibers explained above are core-sheath conjugate fibers wherein the core component is composed of a poly(ethylene terephthalate) (hereinafter referred to as PET), and the sheath component is composed of an isophthalic acid-copolymerized poly(alkylene terephthalate) (hereinafter referred to as I-PET) having a melting or softening point of from 50 to 220° C. When the core component of the core-sheath conjugate fibers is formed from a polyolefin such as a polypropylene or an aliphatic polyamide, or such a poly(alkylene terephthalate) having a longer chain diol component than a PET as poly(trimethylene terephthalate) and poly(butylene terephthalate), adequate bulkiness and a repulsion property cannot be imparted to the nonwoven fabrics formed by the air-laid method. Moreover, conjugate fibers prepared from a poly(alkylene naphthalate) such as polyethylene-2,6-naphthalene show high rigidity. Although fabrics obtained therefrom such as nonwoven fabrics have a good repulsion property, the fabrics have a high melt viscosity, and stuck fiber bundles produced in the course of melt spinning lower the grade of the web formation.

The PET herein designates a polyester comprising ethylene terephthalate repeating units as major repeating units in an amount of 85% by mole or more, preferably 95% by mole or more. Moreover, the PET may contain a small amount of copolymerized components other than a terephthalic acid component and an ethylene glycol component as long as the effects of the present invention are not impaired. A PET showing an intrinsic viscosity of from 0.50 to 0.70 is preferred in view of the melt-spinnability. Moreover, PET may contain known additives such as pigments, delustering agents, antibacterial agents, deodorants, fluorescent brighteners and ultraviolet-ray absorbers as long as the effects of the invention are not impaired.

Although an I-PET that is a heat-bonding component of the sheath component may either be crystalline or amorphous, it is preferred that the I-PET has a melting or softening point of from 50 to 200° C., preferably from 60 to 200° C. When the I-PET has a melting or softening point of less than 50° C., stuck fiber bundles produced due to sticking of fibers during spinning cannot be decreased, sometimes. When the I-PET has a melting point higher than 220° C., the fibers cannot be used as heat-bonding fibers for, for example, air-laid nonwoven fabrics, sometimes, because the fibers manifest no heat-bonding functions.

Typical examples of 1-PET mentioned above are as described above.

Furthermore, the dry thermal shrinkage ratio of the heat-bonding polyester conjugate fibers at 80° C. (hereinafter referred to as a dry thermal shrinkage ratio at 80° C.) is preferably from 5 to 15%, more preferably from 6 to 10%. In addition, the dry thermal shrinkage ratio at 80° C. is measured while the fibers are in a tow state prior to cutting into fiber pieces having a given fiber length, and calculated from the following formula:

dry thermal shrinkage ratio at 80° C.(%)=[(L₀−L₁)/L₀]×100

wherein L₀ and L₁ represent a spacing between reference lines of the tow prior to heat treatment and a spacing subsequent to heat treatment at 80° C. for 20 minutes under no load in a hot-air drying apparatus, respectively. In addition, measurements of L₀ and L₁ are made while an initial load of 0.040 cN/dtex is being applied.

When the dry thermal shrinkage ratio at 80° C. is less than 5%, crimping manifestation subsequent to heat treatment becomes insufficient, and the bulkiness of the nonwoven fabric becomes inadequate sometimes. When the dry thermal shrinkage ratio at 80° C. exceeds 15%, the number of crimps subsequent to heat treatment becomes excessive, and the fiber length becomes short. As a result, the bonding function of the fibers is not manifested sufficiently, and the tenacity of the nonwoven fabric becomes inadequate sometimes.

Furthermore, the thermal shrinkage stress peak temperature of the heat-bonding polyester conjugate fibers of the present invention is preferably from 65 to 85° C., more preferably from 70 to 80° C. When the thermal shrinkage stress peak temperature is less than 65° C., high atmospheric temperature during storage or fretting heat during the air-laid stage sometimes allows the latent crimps of the fibers to manifest. As a result, the dispersibility of the fibers becomes poor, and the uniformity of the web formation is sometimes impaired. Moreover, when the thermal shrinkage peak temperature exceeds 85° C., the latent crimp manifestation during heat treatment becomes poor, and sufficient bulkiness and a satisfactory repulsion property of the nonwoven fabric cannot be obtained sometimes.

Furthermore, it is preferred that the heat-bonding polyester conjugate fibers of the above embodiment do not contain stuck fiber bundles in an amount exceeding 0.03% by weight. The stuck fiber bundles herein refer to at least two conjugate fiber filaments in a melt-stuck state. The percentage by weight of stuck fiber bundles contained in the conjugate fibers is defined as a content of stuck fiber bundles. When the content of stuck fiber bundles exceeds 0.03%, many stuck fiber masses are manifested in the formation of the nonwoven fabric thus obtained. Consequently, the grade of the nonwoven fabric becomes poor, and the nonwoven fabric cannot be used as a product, sometimes.

The heat-bonding polyester conjugate fibers in the above embodiment can be produced by the following procedure. That is, a pelletized PET and a pelletized I-PET are each dried, and separately melted with a conjugate spinning apparatus equipped with two screw extruders. The molten PET and I-PET are introduced into a spinning block, and conjugated in an eccentric core-sheath structure and extruded through a spinning pack into which an eccentric core-sheath type conjugate spinneret is incorporated.

It is herein preferred that the molten PET and I-PET be introduced into the spinning pack while the molten PET and I-PET are being held at temperatures of from 265 to 280° C. and from 180 to 230° C., respectively. When the temperature of the molten PET exceeds 280° C. or that of the molten I-PET exceeds 230° C., the filamentary flow of the extruded molten polymers is inadequately cooled, sometimes. Consequently, many stuck fiber bundles are generated, sometimes. When the temperature of the molten PET is less than 265° C., the melting viscosity of the polymer flow drastically increases, and spinning sometimes becomes difficult. Moreover, when the temperature of the molten I-PET is less than 180° C., the molten polymer temperature becomes so low, at the extrusion face of the spinneret, that spinning becomes difficult sometimes.

The extruded filamentary polymer is preferably cooled and solidified with cooling air held at temperatures of from 15 to 40° C. When the cooling air temperature is less than 15° C., the spinneret face temperature sometimes becomes insufficient. When the cooling air temperature is 40° C. or more, sticking of the fibers takes place sometimes due to insufficient cooling. When filaments that are not solidified sufficiently are cooled with a liquid such as water, cohesion of filaments sometimes takes place due to the surface tension of the liquid, and sticking of the filaments is promoted. Use of air cooling is therefore preferred.

When the filaments are cooled and solidified, a finish oil emulsion is applied thereto. The filaments are then taken up at a rate of from 150 to 3,000 m/min to give undrawn conjugate fibers. An aqueous emulsion of a polyether polyester copolymer containing as major components poly(ethylene glycol) and poly(ethylene terephthalate isophthalate) segments can be preferably used as the finish oil emulsion.

The undrawn conjugate fibers thus obtained are successively drawn in a hot water bath of a drawing apparatus equipped with a hot water drawing bath.

The draw ratio in terms of a total draw ratio (hereinafter referred to as TDR) in the embodiment is preferably from 0.7 to 0.95 times the maximum draw ratio in hot water at 45° C. (hereinafter referred to as HDR) of the undrawn yarn. The HDR herein is a value obtained by the following procedure. An undrawn filament sampled within 5 minutes directly after spinning is held between chucks with a chuck-to-chuck distance set at 10 cm in hot water at 45° C., and drawn at a rate of 5 cm/sec so that the sample filament does not slip. The chuck-to-chuck distance (cm) obtained when the filament is no longer elongated, is divided by the initial chuck-to-chuck distance (10 cm) to give the HDR value.

When the TDR is less than 0.7 times the HDR, the conjugate fibers show a low shrinkage stress, and sufficient latent crimpability cannot be imparted thereto. As a result, crimp manifestation subsequent to heat treatment sometimes becomes insufficient. Moreover, when TDR exceeds 0.95 times HDR, the dry thermal shrinkage ratio at 80° C. of the conjugate fibers becomes less than 5%. As a result, heat generation of three-dimensional crimping caused by heat treatment of the conjugate fibers becomes insufficient, and the bulkiness of desired fiber products such as nonwoven fabrics sometimes becomes inadequate.

It is preferred to carry out the drawing stage of the heat-bonding polyester conjugate fibers by the following procedure. A first stage drawing is carried out in hot water at temperatures of from 70 to 80° C. until the draw ratio reaches from 0.6 to 0.90 times the TDR, and then a second stage drawing is carried out in hot water at temperatures of from 60 to 80° C. until the draw ratio reaches the TDR.

When the hot water temperature of the drawing bath is less than 70° C., single filament breakage of the undrawn filaments takes place in the drawing bath to produce many stuck filament bundles sometimes. Moreover, when the hot water temperature of the drawing bath exceeds 80° C., the thermal stress peak temperature of the conjugate fibers exceeds 85° C., and the latent crimp manifestation sometimes becomes insufficient. When the first stage draw ratio is less than 0.6 times the TDR, the shrinkage stress of the conjugate fibers becomes low, and the latent crimp manifestation sometimes becomes insufficient. When the first stage draw ratio exceeds 0.90 times the TDR, the dry thermal shrinkage ratio at 80° C. of the conjugate fibers becomes less than 5%, and sufficient three-dimensional crimpability cannot be obtained sometimes.

The second stage drawing is preferably conducted in hot water at temperatures of from 60 to 80° C. until the draw ratio reaches a TDR designed. When the hot water temperature is less than 60° C., the dry thermal shrinkage ratio at 80% of the conjugate fibers thus obtained exceeds 15%, and the bonding strength of the conjugate fibers sometimes becomes insufficient because the number of crimps manifested after heat treatment becomes excessive. On the other hand, when the hot water temperature exceeds 80° C., the thermal stress peak temperature exceeds 85° C., and the latent crimping manifestation sometimes becomes poor.

Suitable finish oil is applied to the conjugate fibers subsequent to finishing drawing in accordance with desired properties, particularly in accordance with the processability. The conjugate fibers are then dried, relaxation heat treated, treated with a machine crimping apparatus such as a crimper so that the number of crimps and the shrinkage ratio are adjusted to from 1 to 13/25 mm and from 2 to 20%, respectively, and cut into fiber pieces having a fiber length of from 3 to 20 mm.

The machine-crimped fibers having latent three-dimensional crimpability of the present invention are processed to give desired fiber products. Air-laid nonwoven fabrics are preferred as the fiber products. The fiber products containing machine-crimped fibers of the present invention, preferably nonwoven fabrics formed by the air-laid method are heat treated to manifest latent three-dimensional crimps of the machine-crimped fibers while the fibers are substantially in a strainless state, that is, the machine-crimped fibers of the present invention are in a relaxed state. A hot air circulation system with dry heat, a wet heat system with heated steam, or the like system can be used for the relaxation heat treatment. A shrink drier and a heat treating machine with a suction band system that can blow hot air on both sides of the fiber products to be treated are preferably used for the heat treatment by a hot air circulation system.

When the machine-crimped fibers of the present invention are used for a desired fiber product as a major component, the heat treatment temperature in the relaxation heat treatment of the fiber product is set at temperatures lower by from 5 to 30° C. than the melting point of the polymer contained in the machine-crimped fibers and having the lowest melting point of polymers therein. When a difference between the set temperature and the melting point of the low-melting point polymer is less than 5° C., the machine-crimped crimped fibers manifest latent crimpability. However, the low-melting point polymer is melted sometimes, and the fiber product such as nonwoven fabrics becomes entirely stiff.

On the other hand, when the machine-crimped conjugate fibers of the invention are subjected to relaxation heat treatment at low temperatures exceeding the melting point of the low-melting point polymer by 30° C., the manifested crimps of the fibers sometimes become insufficient, and the bulkiness of the fiber products such as nonwoven fabrics sometimes become inadequate. Moreover, when the machine-crimped conjugate fibers of the present invention are used as binder fibers, the heat treatment temperature is preferably set at temperatures exceeding the melting point of the low-melting point synthetic polymer contained in the conjugate fibers by 10° C. or more, and at temperatures lower than the high-melting point synthetic polymer.

When the heat treatment temperature exceeds the melting point of the low-melting point synthetic polymer in the conjugate fibers by less than 10° C., the fibers sometimes do not manifest properties as binder fibers. Moreover, when the heat treatment temperature exceeds the melting point of the high-melting point synthetic polymer, the entire binder fibers are sometimes melted. As a result, the feeling of the fiber products such as nonwoven fabrics sometimes becomes stiff, or the bulkiness thereof sometimes becomes insufficient.

In addition, the machine-crimped fibers of the present invention may contain, as long as the properties thereof are not impaired, one or more of additives such as catalysts, anticoloring agents, heat-resistant agents, flame retardants, delustering agents, fluorescent brighteners, coloring agents, lubricants, antioxidants, ultraviolet-ray absorbers, hydrophilic agents, water-repelling agents, antibacterial agents, deodorants, aromatic agents and functional ceramics.

### EXAMPLES

The present invention will be further explained below by making reference to examples.

Synthetic polymers, fibers and fiber products used in Examples 1 to 6 and Comparative Examples 1 to 3 described below were subjected to the following tests.

(a) Intrinsic Viscosity ([η])

The intrinsic viscosity of a polyester is measured at 35° C. while o-chlorophenol is used as a solvent.

(b) Melt Flow Rate (MFR)

The melt flow rate of a synthetic polymer is measured in accordance with JIS K 7210.

(c) Melting Point (Tₘ)

The melting point of a synthetic polymer is represented by a heat absorption peak temperature in a DSC curve obtained with a differential scanning calorimetry (DSC) in accordance with JIS K 7121.

(d) Softening Point (Tₘ)

The softening point of a synthetic polymer is restricted to a synthetic polymer having no crystalline melting point, and is represented by a transition temperature in a DSC curve obtained by differential scanning calorimetry in accordance with JIS K 7121.

(e) Number of Crimps, Crimp Ratio

Individual fibers are sampled from a sample filament tow prior to cutting to into fiber pieces having a given fiber length, and the number of crimps and crimp ratio are measured in accordance with JIS L 1015 7.12. In addition, as to the three-dimensional crimps of sample fibers subsequent to heat treatment, a filament tow heat treated without cutting is separated into individual fibers; the individual fibers are heat treated at 160° C. for 2 minutes (at 180° C. for 2 minutes when the fibers are binder ones and are not bonded by heat treatment at 160° C. for 2 minutes) with a hot-air drying apparatus, and cooled to room temperature, and the number of crimps and crimp ratio are measured by the above method. For the number of three-dimensional crimps, one cycle of a spiral is counted as two crimps.

(f) Thickness

The thickness of a sample fiber is measured in accordance with JIS L 1015 7.5.1 A.

(g) Fiber Length

The fiber length of a sample fiber is measured in accordance with JIS L 1015 7.4.1 C.

(h) Deposit Ratio of Finish Oil

A fiber sample having a given fiber weight is extracted for 10 minutes in a methanol bath at 30° C. with a bath ratio of 1:20. The sample weight subsequent to extraction is measured. The deposit ratio of finish oil of the sample fibers is represented by a value obtained by dividing the measured sample weight by the initial sample weight.

(i) Thermal Shrinkage Stress Peak Temperature

A fiber sample is provided to a shrinkage stress measurement apparatus manufactured by KANEBO, LTD. A ring-like yarn 5 cm long is prepared, and both ends of the yarn are held by a measurement holding portion. The yarn is heated at a rate of 120 sec/300° C. with an initial load of 0.09 cN/dtex. The thermal shrinkage stress peak temperature of the fiber is represented by a temperature at which the shrinkage stress of the sample yarn becomes maximum.

(j) Bulkiness of Nonwoven Fabric

The average thickness of a nonwoven fabric sample obtained by heat treating an air-laid web that is prepared by the process described below and that has basis weight of 35 g/m² is measured, and the bulkiness of the nonwoven fabric is represented by the average thickness.

Using a forming drum unit (600 mm wide, having a rectangular hole shape of 2.4 mm×20 mm and a rate of hole area of 40%) manufactured by Dan-Web forming Ltd., an air-laid web having basis weight of 35 g/m² is prepared from the sample fibers under the following conditions: a number of drum revolutions of 200 rpm; a number of needle roll revolutions of 900 rpm; and a web transfer speed of 30 m/min. Air-laid web samples each having a size of 25 cm×25 cm are cut out of the air-laid web. The samples are heat treated at 160° C. for 2 minutes (when the binder fibers are not bonded by heat treatment at 160° C. for 2 minutes, the samples are heat treated at 180° C. for 2 minutes). The thickness of the 5 air-laid nonwoven fabric samples is measured, and the average value is calculated.

(k) Uniformity of Web Formation

The air-laid nonwoven fabric prepared in (j) mentioned above is cut into a strip-like form having a width of 3 cm in the proceeding direction of the web production, and a length of 60 cm in the width direction of the production. The strip-like fabric is cut to give 20 samples each having a size of 3 cm×3 cm. The weight of each of the 20 samples is measured, and the uniformity of the web formation is represented by the variation coefficient (standard deviation/average value). When the variation coefficient is smaller, the web formation is more uniform. Moreover, whether the air-laid web samples have fiber opening or not on the surface is observed.

### Example 1

Polyethylene terephthalate (hereinafter referred to as PET) pellets having an intrinsic viscosity [η] of 0.64 and a melting point Tₘ of 256° C. were dried at 170° C. for 7 hours, melted at 290° C. with a screw extruder, introduced into a spin block held at 280° C., and extruded in a filamentary form at an extrusion rate of 190 g/min through a spinneret for forming hollow fibers prepared by perforating 210 extrusion orifices for forming hollow fibers. A cooling air at 25° C. was blown at a rate of 1.2 m/sec onto the extruded filamentary molten flow at a site 15 mm below the spinneret face from one side of the molten flow at an angle vertical to the proceeding direction of the molten flow. The resultant cooled and solidified undrawn filaments were taken up at a rate of 1,150 m/min to give undrawn PET filaments.

A plurality of undrawn filaments thus obtained were paralleled to form a tow of 500,000 dtex. The tow was subjected to a hot-water drawing stage including two drawing stages. In the first drawing stage, the tow was drawn at a draw ratio of 1.9 at a drawing temperature of 70° C.; in the second drawing srawing stage, the tow was further drawn at a draw ratio of 1.05 at a drawing temperature of 90° C. The tow was totally drawn at a draw ratio of 2.0. Spinning oil prepared by mixing potassium laurylphosphate and polyoxyethylene-modified silicone in a mass ratio of 80:20 was applied to the drawn filaments in an amount of 0.20% by mass. The filament tow was machine crimped with a gear-crimping machine to have a number of crimps of 2/25 mm and a crimp ratio of 5%, and then the crimped filament tow was cut into a fiber length of 5 mm. The machine-crimped fibers thus obtained had an individual fiber thickness of 4.0 dtex, and a hollow ratio of 33%. The machine-crimped hollow polyester fibers thus obtained are hereinafter referred to as the fibers (A).

The fibers (A) were heat treated at 160° C. for 2 minutes to manifest spiral three-dimensional crimps having a number of crimps of 18/25 mm and a crimp ratio of 35%. Moreover, the fibers (A) showed a thermal shrinkage stress peak temperature of 95° C.

Separately from the fibers (A), concentric core-sheath conjugate fibers were prepared in the following manner. A PET having an intrinsic viscosity [η]of 0.64 and a melting point Tₘ of 256° C. was used as a core component. An amorphous copolymerized poly(ethylene terephthalate) (hereinafter referred to as co-PET) prepared by copolymerizing acid components that were composed of a terephthalic acid component and an isophthalic acid component in a molecular ratio of 60:40 and diol components that were composed of ethylene glycol and diethylene glycol in a molecular ratio of 95:5, and having an intrinsic viscosity [α]of 0.56 and a softening point Tₛ of 64° C. was used as a sheath component. Concentric core-sheath conjugate fibers having a core/sheath mass ratio of 50/50 were prepared from the core component and the sheath component. The conjugate fibers (hereinafter referred to as fibers (B)) were solid, and had an individual fiber thickness of 2.2 dtex, a fiber length of 5 mm, and mechanical crimps with a number of crimps of 11/25 mm and a crimp ratio of 12%.

Similarly to the fibers (A), spinning oil prepared by mixing potassium laurylphosphate and polyoxyethylene-modified silicone in a mass ratio of 80:20 was applied to the fibers (B) in an amount of 0.25% by weight. When the fibers (B) were heat treated at 160° C. for 2 minutes, the fibers (B) manifested two-dimensional crimps, and showed a number of crimps of 10/25 mm and a crimp ratio of 15%. However, no distinct spiral three-dimensional crimps were observed. The fibers (B) showed a thermal shrinkage stress peak temperature of 110° C.

Next, the fibers (A) as a major component for forming a web and the fibers (B) as a heat-bonding component therefor were blended in a fibers (A)/fibers (B) mass ratio of 85/15 with basis weight of 35 g/m². The mixture was formed into a web by the air-laid method. The web was heat treated at 160° C. for 2 minutes without tension in a hot-air drying apparatus to give an air-laid nonwoven fabric having basis weight of 35 g/m². The formation uniformity of the nonwoven fabric was 0.03, and no unopened fiber mass was observed. The nonwoven fabric had a thickness representing bulkiness of 9 mm, and manifested sufficient bulkiness.

### Comparative Example 1

A bulky web was prepared in a similar manner as in Example 1 except that in the preparation of fibers (A), the fibers were cut into fiber pieces having a length of 5 mm without machine crimping and relaxation heat treated at 135° C. The fibers manifested spiral three-dimensional crimps, and had a number of crimps of 11.2/25 mm and a crimp ratio of 33%. The fibers thus obtained were PET fibers (hereinafter referred to as fibers (C)), had an individual fiber thickness of 4.5 dtex and a hollow ratio of 32%, and showed no thermal shrinkage stress peak temperature. When the fibers (C) were heat treated at 160° C. for 2 minutes, the fibers (C) manifested spiral three-dimensional crimps having a number of crimps of 19/25 mm and a crimp ratio of 34%.

The fibers (C) and the fibers (B) in Example 1 were blended in a mass ratio of 85:15. The mixture was formed into a web by the air-laid method. The web was then heat treated at 160° C. for 2 minutes in a hot-air drying apparatus to give an air-laid web having basis weight of 35 g/m². Although the air-laid nonwoven fabric had a bulkiness of 7 mm, the formation uniformity was unpreferably 0.24. Moreover, many unopened fiber masses were observed on the nonwoven fabric surface.

### Example 2

PET pellets having an intrinsic viscosity [η] of 0.40 and a melting point Tₘ of 256° C. and 5-sodiosulfoisophthalic acid (2.6 mole)-copolymerized poly(ethylene terephthalate) (hereinafter referred to as CD-PET) pellets having a melting point (Tm) of 253° C. were each dried at 170° C. for 7 hours. The PET pellets and the CD-PET pellets were each melted at 295° C. with a conjugate apparatus equipped with two screw extruders. Both molten bodies were introduced into a spin block held at 280° C., conjugated so that the PET segment and the CD-PET segment were bonded together in a side-by-side manner through a spinning pack for forming hollow side-by-side conjugate fibers having an incorporated spinneret that was prepared by perforating 600 extrusion orifices for hollow side-by-side conjugate fibers, and extruded in a filamentary form at a total extrusion rate of 350 g/min. A cooling air at 30° C. was blown at a rate of 0.5 m/sec onto the extruded filamentary molten flow at a site 30 mm below the spinneret face from one side of the molten flow at an angle vertical to the proceeding direction of the molten flow. The resultant cooled and solidified undrawn filaments were taken up at a rate of 1,100 m/min to give PET/CD-PET (conjugate mass ratio of 50/50) undrawn conjugate filaments.

Next, the undrawn filaments thus obtained were paralleled to form a tow of 500,000 dtex. The tow was subjected to hot-water drawing at a drawing temperature of 70° C. to be drawn at a draw ratio of 2.9. Spinning oil prepared by mixing potassium laurylphosphate and polyoxyethylene-modified silicone in a weight ratio of 80:20 was applied to the drawn filaments in an amount of 0.20% by weight. The filament tow was machine crimped with a crimper to have two-dimensional zig-zag crimps with a number of crimps of 11/25 mm and a crimp ratio of 11%. The fibers were then cut into fiber pieces having a fiber length of 5 mm to give conjugate fibers (hereinafter referred to as fibers (D)) having an individual fiber thickness of 1.8 dtex and a fiber cross-sectional shape (hollow ratio of 3%) as shown in FIG. 2.

The fibers (D) were heat treated at 160° C. for 2 minutes to manifest spiral three-dimensional crimps having a number of crimps of 50/25 mm and a crimp ratio of 45%. Moreover, the fibers (D) showed a thermal shrinkage stress peak temperature of 135° C.

Next, the fibers (D) as a major component for forming a web and the fibers (B) as a heat-bonding component therefor were blended in a fibers (D)/fibers (B) mass ratio of 85/15. The mixture was formed into a web having basis weight of 35 g/m² by the air-laid method. The web was heat treated at 160° C. for 2 minutes in a hot-air drying apparatus to give an air-laid nonwoven fabric having basis weight of 35 g/m². The formation uniformity of the nonwoven fabric was 0.02, and no unopened fiber mass was observed. The nonwoven fabric had a nonwoven fabric bulkiness of 8 mm, and manifested sufficient bulkiness.

### Comparative Example 2

An air-laid nonwoven fabric was prepared in the same manner as in Example 1 except that fibers (E) were prepared by crimping the fibers with a crimper so that two-dimensional zig-zag crimps having a number of crimps of 18/25 mm and a crimp ratio of 23% were imparted. When the fibers (E) were heat treated at 160° C. for 2 minutes, the fibers (E) manifested spiral three-dimensional crimps having a number of crimps of 50/25 mm and a crimp ratio of 45%.

The fibers (E) and fibers (B) were blended in a mass ratio of 85:15, and the mixture was subjected to air-laid forming to give a web. The web was heat treated at 160° C. for two minutes in a hot-air drying apparatus to give an air-laid nonwoven fabric having basis weight of 35 g/m². The air-laid nonwoven fabric had a nonwoven fabric bulkiness of 5 mm. That is, the nonwoven fabric manifested no sufficient bulkiness. Moreover, the formation uniformity was 0.13, and many unopened fiber masses were observed on the web surface.

### Comparative Example 3

A nonwoven fabric was prepared in the same manner as in Example 2 except that PET pellets having an intrinsic viscosity [η]of 0.64 and a melting point Tₘ of 256° C. were used in place of the PET having an intrinsic viscosity [η] of 0.40 and a melting point Tₘ of 256° C. Conjugate fibers (F) having manifested two-dimensional zig-zag crimps with a number of crimps of 11/25 mm and a crimp ratio of 11%, an individual fiber thickness of 2.0 dtex and a fiber cross section (hollow ratio of 3%) as shown in FIG. 2 were prepared.

When the fibers (F) were heat treated at 160° C. for 2 minutes, the fibers (F) manifested spiral three-dimensional crimps having a number of crimps of 22/25 mm and a crimp ratio of 15%. Moreover, the fibers (F) showed a thermal shrinkage stress peak temperature of 155° C.

The fibers (F) and fibers (B) were blended in a mass ratio of 85:15, and the mixture was subjected to air-laid forming to give a web having basis weight of 35 g/m². The web was heat treated at 160° C. for two minutes in a hot-air drying apparatus to give an air-laid nonwoven fabric having basis weight of 35 g/m². The air-laid nonwoven fabric had a formation uniformity of 0.02, and showed a uniform surface. However, the nonwoven fabric had a nonwoven fabric bulkiness of 3 mm, and substantially manifested no bulkiness.

### Example 3

PET pellets having an intrinsic viscosity [η] of 0.64 and a melting point Tₘ of 256° C. were dried at 170° C. for 7 hours. High density polyethylene (hereinafter referred to as HDPE) pellets having a melt flow rate (MFR) of 20 g/10 min and a melting point Tₘ of 135° C. were prepared.

Using a conjugate spinning apparatus equipped with two screw extruders, the dried PET pellets were fed to one of the extruders, and melted at 290° C. On the other hand, the HDPE pellets were fed to the other extruder without drying, and melted at 250° C. The extruded two molten flows were introduced into a spin block held at 280° C., conjugated so that the PET formed cores and the HDPE formed sheaths through a spin pack for forming hollow eccentric core-sheath conjugate fibers having an incorporated spinneret that was prepared by perforating 600 extrusion orifices for forming hollow eccentric core-sheath conjugate fibers, and extruded in a filamentary form at a total extrusion rate of 440 g/min. Cooling air at 30° C. was blown at a rate of 0.5 m/sec onto the extruded filamentary molten flow at a site 40 mm below the spinneret face from one side of the conjugate filament flow at an angle vertical to the proceeding direction of the flow to cool and solidify the filaments. The resultant spun filaments were taken up at a rate of 1,100 m/min to give PET/HDPE (conjugate mass ratio of 50/50) undrawn hollow conjugate filaments.

The undrawn hollow conjugate filaments thus obtained were doubled to form a tow of 400,000 dtex. The tow was subjected to hot-water drawing at a drawing temperature of 70° C. to be drawn at a draw ratio of 3.0. Spinning oil prepared by mixing potassium laurylphosphate and polyoxyethylene-modified silicone in a mass ratio of 80:20 was applied to the tow in an amount of 0.25% by weight. The tow was machine crimped with a crimper to have two-dimensional zig-zag crimps with a number of crimps of 11/25 mm and a crimp ratio of 11%. The fibers were then cut into fiber pieces having a fiber length of 5 mm to give without relaxation thermal shrinkage treatment conjugate fibers (hereinafter referred to as fibers (G)) having an individual fiber thickness of 2.4 dtex and a fiber cross-sectional shape (hollow ratio of 2%) as shown in FIG. 1.

The fibers (G) were heat treated at 160° C. for 2 minutes to manifest spiral three-dimensional crimps having a number of crimps of 35/25 mm and a crimp ratio of 40%. Moreover, the fibers (G) showed a thermal shrinkage stress peak temperature of 95° C.

The fibers (G) alone were air-laid formed into a web having basis weight of 35 g/m². The web was heat treated at 160° C. for 2 minutes in a hot-air drying apparatus to give an air-laid nonwoven fabric having basis weight of 35 g/m². The formation uniformity of the nonwoven fabric was 0.02, and no unopened fiber mass was observed. The nonwoven fabric had a web bulkiness of 7 mm, and manifested sufficient bulkiness.

### Example 4

PET pellets having an intrinsic viscosity [η] of 0.64 and a melting point Tₘ of 256° C. were dried at 170° C. for 7 hours. Moreover, co-PET pellets having an intrinsic viscosity [η] of 0.56 and a softening point Tₘ of 64° C. were dried under a reduced pressure of 1.3 kPa for 24 hours.

Using a conjugate spinning apparatus equipped with two screw extruders, the dried PET pellets were fed to one of the extruders, and melted at 290° C., and co-PET pellets were fed to the other extruder, and melted at 230° C. The extruded two molten flows were introduced into a spin block held at 280° C., conjugated so that the PET formed cores and the co-PET formed sheaths through a spin pack for forming hollow eccentric core-sheath conjugate fibers having an incorporated spinneret that was prepared by perforating 600 extrusion orifices for forming hollow eccentric core-sheath conjugate fibers, and extruded in a filamentary form at a total extrusion rate of 440 g/min. A cooling air at 30° C. was blown at a rate of 0.5 m/sec onto the extruded conjugate filamentary molten flow at a site 40 mm below the spinneret face from one side of the conjugate filament flow at an angle vertical to the proceeding direction of the flow to cool and solidify the filaments. The resultant spun filaments were taken up at a rate of 1,100 m/min to give PET/co-PET (conjugate mass ratio of 50/50) undrawn conjugate filaments.

A plurality of the undrawn filaments thus obtained were doubled to form a tow of 500,000 dtex. The tow was subjected to hot-water drawing at a drawing temperature of 70° C. to be drawn at a draw ratio of 3.5. Spinning oil prepared by mixing potassium laurylphosphate and polyoxyethylene-modified silicone in a weight ratio of 80:20 was applied to the drawn filaments in an amount of 0.25% by weight. The filament tow was machine crimped with a crimper to have two-dimensional zig-zag crimps with a number of crimps of 11/25 mm and a crimp ratio of 11%. The fibers were then cut into fiber pieces having a fiber length of 5 mm to give without relaxation thermal shrinkage treatment hollow conjugate fibers (hereinafter referred to as fibers (H)) having an individual fiber thickness of 1.9 dtex and a fiber cross-sectional shape (hollow ratio of 2%) as shown in FIG. 1.

The fibers (H) were heat treated at 160° C. for 2 minutes to manifest spiral three-dimensional crimps having a number of crimps of 43/25 mm and a crimp ratio of 45%. Moreover, the fibers (H) showed a thermal shrinkage stress peak temperature of 82° C.

The fibers (H) alone were air-laid formed into a web having basis weight of 35 g/m². The web was heat treated at 160° C. for 2 minutes in a hot-air drying apparatus to give an air-laid nonwoven fabric having basis weight of 35 g/m². The formation uniformity of the air-laid nonwoven fabric was 0.07, and no unopened fiber mass was observed. The nonwoven fabric had a web bulkiness of 7 mm, and manifested sufficient bulkiness.

### Example 5

Poly(butylene terephthalate)(hereinafter referred to as PBT) pellets having an intrinsic viscosity [η]of 0.85 and a melting point Tₘ of 220° C. were dried at 150° C. for 7 hours. Moreover, polyester elastomer (hereinafter referred to as EL-PBT) pellets composed of 60% by weight of a hard segment to be explained below and 40% by weight of a soft segment that was formed from a poly(tetramethylene oxide) glycol with a weight average molecular weight of 1500 and having an intrinsic viscosity [α]of 1.15 and a melting point Tₘ of 153° C. were dried at 110° C. for 12 hours. The hard segment was formed from an acid component that was a mixture of a terephthalic acid component and an isophthalic acid component in a molecular ratio of 70:30 and a diol component that was 1,4-butanediol.

Using a conjugate spinning apparatus equipped with two screw extruders, the dried PBT pellets were melt extruded at 270° C. with one of the extruders, and EL-PBT pellets were melt extruded at 230° C. with the other extruder. The extruded two molten flows were introduced into a spin block held at 270° C., conjugated so that the PBT formed cores and the EL-PBT formed sheaths through a spin pack for forming hollow eccentric core-sheath conjugate fibers having an incorporated spinneret that was prepared by perforating 600 extrusion orifices for forming hollow eccentric core-sheath conjugate fibers, and extruded in a filamentary form at a total extrusion rate of 440 g/min. Cooling air at 30° C. was blown at a rate of 0.5 m/sec onto the extruded conjugate filamentary molten flow at a site 40 mm below the spinneret face from one side of the conjugate filament flow at an angle vertical to the proceeding direction of the flow to cool and solidify the filaments. The resultant spun filaments were taken up at a rate of 1,100 m/min to give PBT/EL-PBT (conjugate mass ratio of 50/50) undrawn conjugate filaments.

The undrawn conjugate filaments thus obtained were doubled to form a tow of 500,000 dtex. The tow was subjected to hot-water drawing at a drawing temperature of 70° C. to be drawn at a draw ratio of 2.8. Spinning oil prepared by mixing potassium laurylphosphate and polyoxyethylene-modified silicone in a weight ratio of 80:20 was applied to the drawn filaments in an amount of 0.23% by weight. The filament tow was machine crimped with a crimper to have two-dimensional zig-zag crimps with a number of crimps of 12/25 mm and a crimp ratio of 7%. The fibers were then cut into fiber pieces having a fiber length of 5 mm to give without relaxation thermal shrinkage treatment conjugate fibers (hereinafter referred to as fibers (I)) having an individual fiber thickness of 3.0 dtex and a fiber cross-sectional shape (hollow ratio of 2%) as shown in FIG. 1.

The fibers (I) were heat treated at 180° C. for 2 minutes to manifest spiral three-dimensional crimps having a number of crimps of 28/25 mm and a crimp ratio of 35%. Moreover, the fibers (I) showed a thermal shrinkage stress peak temperature of 95° C.

The fibers (I) alone were air-laid formed into a web having basis weight of 35 g/m². The web was heat treated at 180° C. for 2 minutes in a hot-air drying apparatus to give an air-laid nonwoven fabric having basis weight of 35 g/m². The formation uniformity of the nonwoven fabric was 0.05, and no unopened fiber mass was observed. The nonwoven fabric had a web bulkiness of 6 mm, and manifested sufficient bulkiness.

### Example 6

PET pellets having an intrinsic viscosity [η] of 0.64 and a melting point Tₘ of 256° C. were dried at 170° C. for 7 hours. Moreover, acid-modified polyethylene (hereinafter referred to as M-PE) pellets prepared by graft copolymerizing a linear low-density polyethylene as a backbone polymer with maleic anhydride and methacrylic acid (a maleic anhydride content of 0.21 g mole/kg and a methacrylic acid content of 0.28 mole/kg) and having a MFR of 18 g/10 min and a melting point Tₘ of 96° C. were dried under a reduced pressure of 1.3 kPa for 24 hours.

Using a conjugate spinning apparatus equipped with two screw extruders, the dried PET pellets were melted and extruded at 290° C. with one of the extruders, and M-PE pellets were melted and extruded at 230° C. with the other extruder. The extruded two molten flows were introduced into a spin block held at 280° C., conjugated so that the PET formed cores and the M-PE formed sheaths through a spin pack for forming hollow eccentric core-sheath conjugate fibers having an incorporated spinneret that was prepared by perforating 600 extrusion orifices for forming hollow eccentric core-sheath conjugate fibers, and extruded in a filamentary form at a total extrusion rate of 440 g/min. Cooling air at 30° C. was blown at a rate of 0.5 m/sec onto the extruded conjugate filamentary molten flow at a site 40 mm below the spinneret face from one side of the conjugate filament flow at an angle vertical to the proceeding direction of the flow to cool and solidify the filaments. The resultant spun filaments were taken up at a rate of 1,100 m/min to give PET/M-PE (conjugate mass ratio of 50/50) undrawn conjugate filaments.

The undrawn filaments thus obtained were paralleled to form a tow of 500,000 dtex. The tow was subjected to hot-water drawing at a drawing temperature of 70° C. to be drawn at a draw ratio of 3.0. Spinning oil prepared by mixing potassium laurylphosphate and polyoxyethylene-modified silicone in a weight ratio of 80:20 was applied to the drawn filaments in an amount of 0.35% by weight. The filament tow was machine crimped with a crimper to have two-dimensional zig-zag crimps with a number of crimps of 10/25 mm and a crimp ratio of 7.5%. The fibers were then cut into fiber pieces having a fiber length of mm to give without relaxation thermal shrinkage treatment conjugate fibers (hereinafter referred to as fibers (J)) having an individual fiber thickness of 2.7 dtex and a fiber cross-sectional shape (hollow ratio of 2%) as shown in FIG. 1.

The fibers (J) were heat treated at 160° C. for 2 minutes to manifest spiral three-dimensional crimps having a number of crimps of 43/25 mm and a crimp ratio of 45%. Moreover, the fibers (J) showed a thermal shrinkage stress peak temperature of 85° C.

The fibers (J) alone were air-laid formed into a web having basis weight of 35 g/m². The web was heat treated at 160° C. for 2 minutes in a hot-air drying apparatus to give an air-laid nonwoven fabric having basis weight of 35 g/m². The formation uniformity of the air-laid nonwoven fabric was 0.07, and no unopened fiber mass was observed. The nonwoven fabric had a web bulkiness of 7 mm, and manifested sufficient bulkiness.

In Examples 7 to 10 and Comparative Examples 4 to 6, the following tests (1) to (q) were conducted in addition to the above tests: (a) Intrinsic Viscosity ([η]); (c) Melting Point (Tₘ); (d) Softening Point (Tₛ); (f) Thickness; (g) Fiber Length; (h) Deposit Ratio of Finish Oil; and (i) Thermal Shrinkage Stress Peak Temperature.

(l) Dry Thermal Shrinkage Ratio at 80° C.

A tow of about 2,200 dtex is separated from the filament tow prior to cutting the tow into fiber pieces having a given fiber length. Reference lines with a spacing of L₀ are marked on the tow while an initial load of 0.040 cN/dtex is being applied. The tow is subsequently heat treated at 80° C. for 20 minutes in a hot-air drying apparatus without load, and cooled to room temperature. The spacing L₁ between the reference lines is measured while an initial load of 0.040 cN/dtex is being applied, and the dry thermal shrinkage ratio at 80° C. of the sample filaments is calculated from the following formula:

dry thermal shrinkage ratio at 80° C.(%)=[(L₀−L₁)]/L₀]×100

(m) Content of Stuck Fiber Bundles

Stuck fiber bundles contained in a fiber sample in an amount of 10 g is visually detected. The weight percentage of the detected stuck fiber bundles based on the sample weight is measured, and the content of stuck fiber bundles of the fiber sample is represented by the measured value.

(n) Number of Crimps, Crimp Ratio

Individual fibers are sampled from a filament tow prior to cutting into fiber pieces having a given fiber length, and the number of crimps and crimp ratio are measured in accordance with JIS L 1015 7.12. In addition, the three-dimensional crimps of sample fibers subsequent to heat treatment are measured as explained below. A filament tow is separated into individual fibers; the individual fibers are heat treated at 90° C. for 1 minute in a hot-air drying apparatus, and cooled to room temperature, and the number of crimps and crimp ratio are measured by the same method as mentioned above. For the number of three-dimensional crimps, one cycle of a spiral is counted as two crimps.

(o) Formation Uniformity of Nonwoven Fabric

An air-laid web having basis weight of 50 g/m² is heat treated at 150° C. for 2 minutes. A sample having a size of 10 cm×10 cm is cut out of the nonwoven fabric thus obtained, and the sample is further cut at intervals of 2 cm in both the longitudinal direction and the transverse direction to give 25 samples each having a size of 2 cm×2 cm. The 25 samples are each weighed, and the variation coefficient (standard deviation/average value) is defined as the formation uniformity of the web. A smaller variation coefficient of a web signifies that the formation of the web is more uniform.

(p) Thickness of Nonwoven Fabric (Bulkiness)

An air-laid web having basis weight of 50 g/m² is heat treated at 150° C. for 2 minutes, and the average thickness of the nonwoven fabric thus obtained is measured. A nonwoven fabric having a larger thickness indicates that the bulkiness of the fibers forming the nonwoven fabric is larger.

(q) Compression Ratio (Repulsion Property) of Nonwoven Fabric

An air-laid web having basis weight of 50 g/m² is heat treated at 150° C. for 2 minutes in a hot-air drying apparatus. The compression ratio of the nonwoven fabric thus obtained is measured in accordance with JIS L 1097 5.3. A higher compression ratio of a web indicates that the repulsion property of the web is more significant.

In addition, an air-laid web is formed by the following simple method. A heat-bonding conjugate fiber sample is placed on a screen of 5 mesh, passed through the screen by gently blowing air onto the sample to drop and accumulate on a poly(ethylene terephthalate) net of 16 mesh the back surface of which is open to the air.

### Example 7

A PET having an intrinsic viscosity [η]of 0.64 and a melting point Tₘ of 256° C. and an amorphous I-PET prepared by copolymerizing acid components that were composed of a terephthalic acid component and an isophthalic acid component in a molecular ratio of 60:40 and diol components that were composed of ethylene glycol and diethylene glycol in a molecular ratio of 95:5 and having an intrinsic viscosity [η]of 0.56 and a softening point Tₘ of 64° C. were each dried, and separately melted with two extruders with which an eccentric core-sheath conjugate melt spinning apparatus was equipped.

The molten PET at 275° C. as a core component and the molten I-PET at 225° C. as a sheath component were introduced into a spin pack having a spinneret for forming eccentric core-sheath conjugate fibers. The two molten polymer flows were conjugated in a conjugation ratio (core/sheath volume ratio) of 50/50, and extruded at 280° C. at a total extrusion rate of 680 g/min through the spinneret prepared by perforating 70 extrusion orifices.

The spun conjugate fibers were cooled with a cooling air, and an aqueous emulsion as spinning oil containing 0.3% by weight of potassium laurylphosphate was applied to the fibers in an emulsion deposit ratio of 15% by weight using an oiling roller. The resultant fibers were taken up at a spinning rate of 500 m/min to give undrawn eccentric core-sheath conjugate fibers. The HDR of the fibers was 4.4.

The undrawn conjugate fibers were bundled to form a tow of 165,000 dtex (150,000 denier). The tow was first drawn in hot water at 75° C. at a draw ratio of 3.2 (0.72 times HDR), further drawn in hot water at 74° C. by draw ratio of 1.25 (4.0 times TDR, TDR/HDR=0.91). Spinning oil prepared by mixing potassium laurylphosphate and polyoxyethylene-modified silicone in a weight ratio of 80:20 was applied to the tow in an amount of 0.25% by weight as a pure component.

The conjugate filament tow was then crimped at 35° C. with a push-on type crimper, dried and relaxation heat treated at 50° C., and cut into fiber pieces having a length of 5 mm to give heat-bonding conjugate fibers having an individual fiber thickness of 52 detx. The heat-bonding conjugate fibers had a number of mechanical crimps of 4/25 mm and a crimp ratio of 7%.

Table 1 shows the properties of the heat-bonding conjugate fibers thus obtained, and the grade and properties of a nonwoven fabric obtained therefrom.

### Example 8

A nonwoven fabric was prepared in the same manner as in Example 7 except that the drawing temperature in the second stage was changed to 69° C. Table 1 shows the properties of the heat-bonding conjugate fibers thus obtained, and the grade and properties of a nonwoven fabric obtained therefrom.

### Example 9

A nonwoven fabric was prepared in the same manner as in Example 1 except that the total extrusion rate was changed to 915 g/min in order to make the thickness 70 dtex. Table 1 shows the properties of the heat-bonding conjugate fibers thus obtained, and the grade and properties of a nonwoven fabric obtained therefrom.

### Comparative Example 4

A nonwoven fabric was prepared in the same manner as in Example 1 except that the drawing temperature in the second stage was changed to 90° C. Table 1 shows the properties of the heat-bonding conjugate fibers thus obtained, and the grade and properties of a nonwoven fabric obtained therefrom.

### Comparative Example 5

A nonwoven fabric was prepared in the same manner as in Example 1 except that the draw ratio in the second stage was changed to 1.4 and the TDR was changed to 4.5 (TDR/HDR=1.02). Table 1 shows the properties of the heat-bonding conjugate fibers thus obtained, and the grade and properties of a nonwoven fabric obtained therefrom.

### Example 10

A PET having an intrinsic viscosity [α]of 0.64 and a melting point Tₘ of 256° C. and a crystalline I-PET prepared by copolymerizing acid components that were composed of terephthalic acid and isophthalic acid in a molecular ratio of 80:20 and diol components that were composed of ethylene glycol and tetramethylene glycol in a molecular ratio of 65:35 and having an intrinsic viscosity [η] of 0.57 and a melting point Tₘ of 155° C. were each dried, and separately melted with an eccentric core-sheath conjugate melt spinning apparatus equipped with two extruders. The molten PET at 275° C. as a core component and the molten I-PET at 215° C. as a sheath component were introduced into a spin pack having a spinneret for forming eccentric core-sheath conjugate fibers. The two molten polymer flows were conjugated in a conjugation ratio (core/sheath volume ratio) of 50/50, and extruded at a spinneret temperature of 280° C. at a total extrusion rate of 680 g/min into a conjugate filamentary shape through the spinneret prepared by perforating 70 extrusion orifices.

The spun conjugate filamentary flow was cooled with a cooling air at 30° C., and an aqueous emulsion as spinning oil containing 0.3% by weight of potassium laurylphosphate was applied to the filaments in an emulsion deposit ratio of 15% by weight using an oiling roller. The resultant filaments were taken up at a spinning rate of 500 m/min to give undrawn core-sheath conjugate filaments. The HDR of the filaments was 4.7.

The undrawn filaments were bundled to form a filament tow of 165,000 dtex (150,000 denier). The tow was first drawn in hot water at 75° C. at a draw ratio of 3.1 (0.66 times HDR), and further drawn in hot water at 65° C. at a draw ratio of 1.3 (4.0 times TDR, TDR/HDR=0.85). Spinning oil prepared by mixing potassium laurylphosphate and polyoxyethylene-modified silicone in a weight ratio of 80:20 was applied to the drawn filament tow in an amount of 0.25% by weight as a pure component.

The drawn filament tow was then naturally cooled to 35° C., crimped with a push-on type crimper, dried and relaxation heat treated at 105° C., and cut into fiber pieces having a length of 5 mm to give heat-bonding conjugate fibers having an individual fiber thickness of 56 detx. The heat-bonding conjugate fibers had a number of mechanical crimps of 4.1/25 mm and a crimp ratio of 15%.

Table 1 shows the properties of the heat-bonding conjugate fibers thus obtained, and the grade and properties of a nonwoven fabric obtained therefrom.

### Comparative Example 6

A PET having an intrinsic viscosity [η]of 0.64 and a melting point Tₘ of 256° C. and a high-density polyethylene (HDPE) having a melt index of 20 g/10 min, melting point (Tₘ) of 131° C. and a true density of 0.95/cm³ were each dried, and melted with an eccentric core-sheath conjugate melt spinning apparatus equipped with two screw extruders.

The molten PET at 290° C. as a core component and the molten HDPE at 250° C. as a sheath component were introduced into a spin pack having a spinneret for forming eccentric core-sheath conjugate fibers. The two molten polymer flows were conjugated in a conjugation ratio (core/sheath volume ratio) of 50/50, and extruded at a spinneret temperature of 280° C. at an extrusion rate of 660 g/min into a conjugate filamentary shape through the spinneret prepared by perforating 70 extrusion orifices.

The spun conjugate filamentary flow was cooled with a cooling air at 30° C., and an aqueous emulsion as spinning oil containing 0.3% by weight of potassium laurylphosphate was applied to the filaments in an emulsion deposit ratio of 15% by weight using an oiling roller. The resultant filaments were taken up at a spinning rate of 500 m/min to give undrawn eccentric core-sheath conjugate filaments. The HDR of the filaments was 4.85.

The undrawn conjugate filaments were bundled to form a filament tow of a total thickness of 132,000 dtex (120,000 denier). The filament tow was first drawn in hot water at 75° C. at a draw ratio of 4.0 (0.82 times HDR), further drawn in hot water at 90° C. at a draw ratio of 1.25 (5.0 times TDR, TDR/HDR=1.03). Spinning oil prepared by mixing potassium laurylphosphate and polyoxyethylene-modified silicone in a weight ratio of 80:20 was applied to the tow in an amount of 0.25% by weight.

The drawn filament tow was then crimped with a push-on type crimper at 40° C., dried and relaxation heat treated at 105° C., and cut into fiber pieces having a fiber length of 5 mm to give heat-bonding conjugate fibers having an individual fiber thickness of 56 dtex. The heat-bonding conjugate fibers had a number of mechanical crimps of 4.3/25 mm and a crimp ratio of 18%.

Table 1 shows the properties of the heat-bonding conjugate fibers thus obtained, and the grade and properties of a nonwoven fabric obtained therefrom.

TABLE 1

| | Ex. 1 | Ex. 2 | Ex. 3 | C. Ex. 1 | C. Ex. 2 | Ex. 4 | C. Ex. 3 |
|---|---|---|---|---|---|---|---|
| Thickness (dtex) | 52 | 52 | 70 | 52 | 52 | 55 | 56 |
| Fiber length (mm) | 5 | 5 | 5 | 5 | 5 | 5 | 5 |
| Dry thermal shrinkage ratio | 7.5 | 10.8 | 7.8 | 1.9 | 3.5 | 11.2 | 0.5 |
| at 80° C. | | | | | | | |
| Thermal stress peak temp. (° C.) | 81 | 74 | 83 | 105 | 85 | 72 | 130 |
| Content of sticked fibers | 0 | 0 | 0 | 0.01 | 0 | 0.01 | 0 |
| Number of crimps after heat | 16.0 | 25.0 | 14.5 | 5.1 | 4.6 | 22.5 | N.M. |
| treatment (1/25 mm) | | | | | | | |
| Uniformity of web formation | 0.08 | 0.11 | 0.06 | 0.09 | 0.10 | 0.05 | 0.17 |
| Nonwoven fabric thickness (mm) | 6.0 | 5.6 | 7.1 | 3.9 | 3.7 | 5.3 | 3.4 |
| Compression ratio of nonwoven | 28 | 16 | 22 | 17 | 16 | 33 | 58 |
| fabric (%) | | | | | | | |

Note: N.M. = Not manifested

### INDUSTRIAL APPLICABILITY

The machine-crimped synthetic fibers having a latent three-dimensional crimpability according to the present invention do not produce poor fiber opening in the production stages of fiber products such as the web formation stage of air-laid nonwoven fabrics. Moreover, heat treatment of the resultant fiber products manifests three-dimensional crimps, and the bulkiness of the fiber products can be significantly and uniformly increased.

Furthermore, when the machine-crimped synthetic fibers having latent three-dimensional crimpability according to the present invention are eccentric core-sheath conjugate fibers having a heat-bonding synthetic resin component, heat treatment of the fiber products manifests three-dimensional crimps, and causes the crimped fibers to be heat bonded together in the portions where the fibers cross each other. As a result, the compression repulsion property of the fiber products and air-laid nonwoven fabrics thus obtained can be significantly improved.

1. Machine-crimped synthetic fibers that have latent crimpability to manifest three-dimensional crimps, comprising as a major component at least one thermoplastic synthetic resin, having an individual fiber thickness of from 0.5 to 200 dtex and a fiber length of from 3 to 20 mm, and showing a number of individual fiber crimps of from 1 to 13/25 mm and a crimp ratio of from 2 to 20% imparted by mechanical crimping,
each of the machine-crimped fibers having two portions disproportional in thermal shrinkability on both respective sides of an imaginary interface dividing the fiber into two along the longitudinal axis, the fiber being disproportionately shrunk on both sides thereof when heat treated at temperatures of from 60 to 200° C. due to the presence of the disproportional two portions, whereby the machine-crimped synthetic fibers are made to show a number of three dimensional crimps of from 15 to 80/25 mm and a crimp ratio of from 25 to 90%.

2. The machine-crimped synthetic fibers according to claim 1, wherein the machine-crimped fibers show a thermal shrinkage stress peak within the temperatures of from 60 to 180° C.

3. The machine-crimped synthetic fibers according to claim 1, wherein the machine-crimped fibers each have at least one hollow portion continuously extending along the longitudinal direction.

4. The machine-crimped synthetic fibers according to claim 1, wherein the machine-crimped fibers each contain, as a major component, a single type of thermoplastic synthetic resin and have two portions on both respective sides of the imaginary interface disproportional in orientation degree and/or crystalline degree.

5. The machine-crimped synthetic fibers according to claim 1, wherein the thermoplastic synthetic resin contains, as a major component, a single type of polyester that contains alkylene terephthalate units as major repeating units.

6. The machine-crimped synthetic fibers according to claim 1, wherein the machine-crimped fibers each comprise two fiber segments containing two respective thermoplastic synthetic resins as major components differing from each other in thermal shrinkability, and the two fiber segments are mutually bonded together to form an eccentric core-sheath structure along the longitudinal axis of the fiber and asymmetric with respect to the imaginary interface, whereby the conjugate fibers are formed.

7. The machine-crimped synthetic fibers according to claim 1, wherein the machine-crimped fibers each comprise two fiber segments containing two respective thermoplastic synthetic resins as major components differing from each other in thermal shrinkability, and the two fiber segments are mutually bonded together to form a side-by-side conjugate structure along the longitudinal axis of the fiber with the imaginary interface forming a bonding plane, whereby the conjugate fibers are formed.

8. The machine-crimped synthetic fibers according to claim 6 or 7, wherein the two types of synthetic resins are each selected from polyester resins having alkylene phthalate units as major repeating units and showing a melting point of 200° C. or more.

9. The machine-crimped synthetic fibers according to claim 6, wherein the two types of fiber segments forming the eccentric core-sheath conjugate structure are composed of a low-melting point synthetic resin and a high-melting point synthetic resin differing from each other in the melting point by 20° C. or more, the fiber segment composed of the low-melting point synthetic resin forms the sheath portion of the eccentric core-sheath conjugate structure, and the fiber segment composed of the high-melting point synthetic resin forms the core portion thereof.

10. The machine-crimped synthetic fibers according to claim 7, wherein the two types of fiber segments forming the side-by-side conjugate structure are composed of a low-melting point synthetic resin and a high-melting point synthetic resin differing from each other in the melting point by 20° C. or more.

11. The machine-crimped synthetic fibers according to claim 9 or 10, wherein the low-melting point synthetic resin is selected from polyolefins, and the high-melting point synthetic resin is selected from polyesters containing alkylene phthalate units as major repeating units.

12. The machine-crimped synthetic fibers according to claim 9 or 10, wherein an isophthalic acid-copolymerized poly(alkylene terephthalate) having a melting point of from 50 to 200° C. is used as the low-melting point synthetic resin, and a poly(alkylene terephthalate) having a melting point higher than that of the low-melting point synthetic resin by 20° C. or more is used as the high-melting point synthetic resin.

13. The machine-crimped synthetic fibers according to claim 9 or 10, wherein the low-melting point synthetic resin is selected from thermoplastic elastomers having a melting point of from 80 to 200° C.

14. The machine-crimped synthetic fibers according to claim 9 or 10, wherein the low-melting point synthetic resin is selected from modified polyolefin resins obtained by graft polymerizing a polyolefin with a graft agent containing at least one substance selected from ethylenic unsaturated carboxylic acids and anhydrides thereof.

15. A process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,
the process comprising:
a melt spinning stage for producing undrawn synthetic resin filaments that comprises, during cooling and solidifying under a draft a filamentary synthetic resin molten flow prepared by melting a single type of thermoplastic synthetic resin and extruding the molten body through a spinneret into a filamentary flow, blowing a cold wind toward the one side of the filamentary synthetic resin molten flow in the direction transverse to the molten flow, whereby both sides of the imaginary interface of each filament along the longitudinal axis and transverse to the blowing direction of the cold wind are made disproportional in an orientation degree and/or a crystalline degree;
a drawing stage for producing drawn synthetic resin filaments having a thickness of from 0.5 to 200 dtex that comprises drawing the undrawn synthetic resin filaments at temperatures lower than the heat treatment temperatures for manifesting the crimps;
a machine crimping stage that comprises machine crimping the drawn synthetic resin filaments to impart a number of crimps of from 1 to 13/25 mm and a crimp ratio of from 2 to 20% to the drawn synthetic resin filaments; and
a cutting stage that comprises cutting the machine-crimped synthetic resin filaments into fiber pieces having a crimp length of from 3 to 20 mm.

16. The production process according to claim 15, wherein the synthetic resin molten body in the melt spinning stage is extruded through a spinneret for forming hollow filaments into a hollow filamentary form.

17. The production process according to claim 15, wherein the thermoplastic synthetic resin provided to the melt spinning stage comprises as a major component a polyester containing alkylene terephthalate units as major repeating units.

18. A process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,
the process comprising:
a melt spinning stage for producing undrawn synthetic resin eccentric core-sheath type conjugate filaments that comprises separately melting two types of thermoplastic synthetic resins differing from each other in thermal shrinkability, extruding the two molten bodies through a spinneret for forming eccentric core-sheath type conjugate fibers into a conjugate filamentary form, and cooling and solidifying under a draft the extruded conjugate filamentary synthetic resin molten flow;
a drawing stage for producing drawn synthetic resin filaments having a thickness of from 0.5 to 200 dtex that comprises drawing the undrawn synthetic resin conjugate filaments at temperatures lower than the heat treatment temperatures for manifesting the crimps;
a machine crimping stage that comprises machine crimping the drawn synthetic resin filaments to impart a number of crimps of from 1 to 13/25 mm and a crimp ratio of from 2 to 20% to the drawn synthetic resin filaments; and
a cutting stage that comprises cutting the machine-crimped synthetic resin conjugate filaments into fiber pieces having a crimp length of from 3 to 20 mm.

19. A process for producing the machine-crimped synthetic fibers according to claim 1 that have latent three-dimensional crimpability to manifest a number of crimps of from 15 to 80/25 mm and a crimp ratio of from 25 to 90% when subjected to crimp manifestation heat treatment at temperatures of from 60 to 200° C.,
the process comprising:
a melt spinning stage for producing undrawn synthetic resin eccentric core-sheath type conjugate filaments that comprises separately melting two types of thermoplastic synthetic resins differing from each other in thermal shrinkability, extruding the two molten bodies through a spinneret for forming side-by-side type conjugate fibers into a conjugate filamentary form, and cooling and solidifying under a draft the extruded conjugate filamentary synthetic resin molten flow;
a drawing stage for producing drawn synthetic resin conjugate filaments having a thickness of from 0.5 to 200 dtex that comprises drawing the undrawn synthetic resin conjugate filaments at temperatures lower than the heat treatment temperatures for manifesting the crimps;
a machine crimping stage that comprises machine crimping the drawn synthetic resin filaments to impart a number of crimps of from 1 to 13/25 mm and a crimp ratio of from 2 to 20% to the drawn synthetic resin filaments; and
a cutting stage that comprises cutting the machine-crimped synthetic resin conjugate filaments into fiber pieces having a crimp length of from 3 to 20 mm.

20. The production process according to claim 18 or 19, wherein the two types of synthetic resins each have alkylene phthalate units as major repeating units and are selected from polyester resins having a melting point of 200° C. or more.

21. The production process according to claim 18, wherein the two types of synthetic resins for producing the eccentric core-sheath conjugate fibers are composed of a low-melting point synthetic resin and a high-melting point synthetic resin, respectively, differing from each other in the melting point by 20° C. or more, the sheath portion of the eccentric core-sheath conjugate fibers is formed from the low-melting point synthetic resin, and the core portion thereof is formed from the high-melting point synthetic resin.

22. The production process according to claim 19, wherein the two types of synthetic resins for producing the side-by-side type conjugate fibers are a low-melting point synthetic resin and a high-melting point synthetic resin, respectively, differing from each other in the melting point by 20° C. or more.

23. The production process according to claim 21 or 22, wherein the low-melting point synthetic resin is selected from polyolefins, and the high-melting point synthetic resin is selected from polyesters containing alkylene phthalate units as major repeating units.

24. The production process according to claim 21 or 22, wherein an isophthalic acid-copolymerized poly(alkylene terephthalate) having a melting point of from 50 to 200° C. is used as the low-melting point synthetic resin, and a poly(alkylene terephthalate) having a melting point higher than that of the low-melting point synthetic resin by 20° C. or more is used as the high-melting point synthetic resin.

25. The production process according to claim 21 or 22, wherein the low-melting point synthetic resin is selected from a thermoplastic elastomers having a melting point of from 80 to 200° C.

26. The production process according to claim 21 or 22, wherein the low-melting point synthetic resin is selected from modified polyolefin resins obtained by graft polymerizing a polyolefin with a graft agent containing at least one substance selected from ethylenic unsaturated carboxylic acids and anhydrides of the acids.

27. The production process according to claim 18, wherein, in the melt spinning stage, a poly(ethylene terephthalate) resin molten body is fed to the spinneret for forming the eccentric core-sheath type conjugate fibers as a synthetic resin for forming the core portion, at temperatures of from 265 to 280° C., an isophthalic acid-copolymerized poly(alkylene terephthalate) resin molten body having a melting or softening point of from 50 to 220° C. is fed thereto as a synthetic resin for forming the sheath portion, at temperatures of from 180 to 230° C., and the conjugate filamentary molten flow thus extruded is uniformly cooled and solidified with cooling air adjusted to temperatures of from 15 to 40° C.

28. The production process according to claim 18, wherein the core portion of the undrawn eccentric core-sheath conjugate filaments is formed from a poly(ethylene terephthalate) resin, the sheath portion is formed from an isophthalic acid-copolymerized poly(alkylene terephthalate) resin having a melting or softening point of from 50 to 220° C., the total draw ratio to be applied to the undrawn conjugate filaments in the undrawing stage is set at from 0.70 to 0.95 times the maximum draw ratio of the undrawn conjugate filaments in hot water at 45° C., the undrawn conjugate filaments are first drawn until the draw ratio reaches from 0.60 to 0.90 times the total draw ratio in hot water at temperatures of from 70 to 80° C., and then the filaments are drawn in hot water at temperatures of from 60 to 80° C. until the draw ratio reaches the total draw ratio designed.

29. A bulky fiber product containing three-dimensionally crimped synthetic fibers obtained by manifesting the latent crimpability of the machine-crimped synthetic fibers according to any one of claims 1 to 14.

30. An air-laid nonwoven fabric containing three-dimensionally crimped synthetic fibers obtained by manifesting the latent crimpability of the machine-crimped synthetic fibers according to any one of claims 1 to 14.
